(19) United States
(12) Patent Application Publication
(10) Pub. No.: US 2019/0150468 A1
(43) Pub. Date: May 23, 2019

(54) Gum Arabic Replacements In: (1) Panning, Confections, Adhesion & Coatings; (2) Edible Films and Flavor Encapsulation; and (3) Lithography

(71) Applicant: Tic Gums, Inc., Belcamp, MD (US)

(72) Inventors: Marceliano B. Nieto, White Marsh, MD (US); Greg Andon, Belcamp, MD (US)

(21) Appl. No.: 15/981,433

(22) Filed: May 16, 2018

Related U.S. Application Data
(63) Continuation of application No. 12/510,093, filed on Jul. 27, 2009, now abandoned.
(60) Provisional application No. 61/083,808, filed on Jul. 25, 2008.

(51) Int. Cl. A23G 3/34; A23L 29/20; A23G 3/42; A23G 4/06; A23P 20/10

(52) U.S. Cl. CPC A23G 3/343; A23L 29/20; A23P 20/105; A23G 4/062; A23G 3/42

(57) ABSTRACT

A method of preparing a gum arabic replacement, partial replacement or extending composition, for use in a variety of applications such as food, pharmaceutical and industrial applications is disclosed. In one embodiment, the invention is directed towards a method of preparing a gum arabic replacement, partial replacement or extending composition for use in panning, candy, coating and adhesion applications. The method includes selecting a strong (key) film former of natural and/or modified polysaccharides that comprises between approximately 0.1% and approximately 10% of the composition, or used at a level in the finished application equivalent to about 0.1 to 10% of what gum arabic would typically be used regardless of whether the gum arabic is used.

This application is a Continuation claiming the benefit of U.S. patent application Ser. No. 12/510,093 filed on Jul. 27, 2009 which claims the benefit of 61/083,808, filed on Jul. 25, 2008, which are hereby incorporated by reference for all purposes as if fully set forth herein.

### BACKGROUND OF THE INVENTION

### Field of the Invention

This disclosure relates generally to gum arabic replacements targeted but not limited to their use in three major categories of applications, including: (1) panning, confections, food/pharmaceutical adhesion and coating; (2) flavor encapsulation/spray dried flavors and edible films; and (3) lithography or printing applications to achieve various functionalities derived from gum Arabic, such as: (1) sugar binding and strengthening of the shell of chewing gum and panned peanuts, chocolate or gum balls; as sealant and oxygen barrier for oil-containing centers such as various nuts, chocolate and malt balls; as texture modifier hardening agent for pastilles and hard candies; as polish to provide a shiny coat for panned products, cereals, tablets and other products and as an adhesive for granola bars, cereal clusters and seeds; (2) as emulsifier and encapsulating agent for flavor oils intended for spray drying and as film former that flakes off in small pieces to make edible glitters; and (3) as a wetting agent and oil/ink-repellant for use in lithography.

### Discussion of the Related Art

Gum arabic is the dried exudate obtained from various species of trees of the genus Acacia of the Leguminosae family in the tropical and semi-tropical areas of the world. Gum arabic has multiple uses in food, pharmaceutical and industrial applications. Currently there are two species of Acacia that are commercially used: Acacia Senegal and Acacia Seyal for food and pharmaceutical applications. However, for industrial applications, specifically in lithography, another tree exudate called Combretum is becoming the standard for replacement. The major producing countries of these species are in the Sahelian region of Africa including the Republic of the Sudan, Chad, Eritrea, Nigeria and neighboring countries. Shortage of gum arabic is not uncommon due to political turmoil in this region of Africa.

The need for gum arabic for food and pharmaceutical applications is very significant. For panning alone, an estimate of worldwide demand for gum arabic is about 20 million pounds per year. In recent years, the supply of gum arabic has been very volatile and unpredictable due to the political instability in the region of Africa where it is sourced. Accordingly, the risk of not having a sufficient supply of gum arabic has become a growing concern.

Gum arabic is a high MW polysaccharide with an unusually low viscosity, behaving as Newtonian liquid up to 35% concentration; it dissolves at concentrations of 55%-60% to make a thick syrup. This low viscosity is attributed to its structural branching, which makes it a globular molecule. This branching prevents micelle formation, unlike linear gums, minimizing intermolecular hydrogen bonding when it is hydrated in water. As a result, it forms a weak film. Its solution gets tacky at high concentrations but gives brittle texture when dried. It forms a shiny film when cast on a surface that cracks in a unique pattern. It has an emulsifying property attributed to the presence of protein that is covalently linked to some portion of the polysaccharide fraction forming a very high MW glycoprotein complex of greater than 2 million Daltons.

Gum arabic is also used in hard panning of chewing gums and chocolate panned confections to bind and strengthen the shell coat that is made up of sugar or sugar alcohols. It is added to the syrup recipe for spraying or ladling onto the centers. Gum arabic is either used only during the initial stage of the panning process for cost reasons, or in all the charges of syrup, especially in sugar-free formulations to help build a strong layer of shell around the chewing gum centers. The need for a good binder in coating and engrossing syrups is a direct result of scale-up or the desire to use larger coating pans to increase capacity, and this results in more breakage of the shell coat as the centers tumble in the pan. In many other instances, cracking happens during packaging, transport of the finished product and when consumers shake the packaging container. Even in regular sugar panning, the need to strengthen the shell during the coating process becomes critical because of the use of large pan coaters. Maltodextrin, a cheaper substitute for binding the sugar in the regular syrup coating, may work satisfactorily when coating pans and batch sizes are small; however, it fails as a gum arabic replacement when using larger coating pans and batch sizes due to weaker and crumblier crystals.

Acacia Senegal is a premium grade of gum arabic that is a natural emulsifier mainly used in beverage emulsions, savory flavor emulsions and spray dried flavors; Acacia Seyal is a grade of gum arabic that has limited emulsifying properties but has lower cost structure. Acacia Seyal has replaced Senegal in many applications where emulsification is secondary or not critical. Replacements for Acacia Senegal in beverage emulsions have been developed and commercialized, such as various emulsifying starches and the OSA-modified gum Acacia made from Acacia Seyal as disclosed in U.S. Pat. No. 6,455,512. In flavor encapsulation/spray dried flavors, straight Acacia Seyal, blends containing Acacia Seyal and modified gum arabic and blends containing emulsifying starches with maltodextrin have partly replaced Acacia Senegal. Embodiments of the invention differ from these current replacements in composition of ingredients that were evaluated and chosen based on their contribution to matching key properties of gum arabic in various applications, or in some cases, improving the functionality of the replacements over that of gum arabic while reducing or matching cost.

In other applications such as panning and confections, the main replacement for gum arabic is the use of Acacia Seyal in place of Acacia Senegal, a practice that will not solve the impending shortage problem with gum arabic. Hard panning or coating of comestible or pharmaceutical compositions that use sugars, such as, sucrose, dextrose, fructose or glucose syrups, or use sugar-free compositions containing maltitol, erythritol, sorbitol, xylitol, mannitol or hydrogenated starch hydrolysates almost always requires the use of gum arabic for binding, strengthening of the shell or sealing. The process for applying the coatings to the cores generally consists of tumbling the cores in a rotating pan at a desired speed and temperature, applying multiple charges of the coating in a liquid form and drying the coating in between coat application. The coating process is repeated until the shell coat has the desired thickness, about 30-33% of the product weight. Variations of this process have been developed.

In edible film and glitter applications where viscosity, clarity and specific film cracking pattern and adhesion/release from the casting belt are critical, gum arabic is still the sole gum material currently used for this purpose.

In lithography, oil and gum arabic are used to divide the smooth surface, such as limestone or a metal plate, into hydrophobic regions that accept the ink and hydrophilic regions that reject it and thus become the background. The image is drawn on the surface of the print plate with a fat or oil-based medium (hydrophobic), which may be pigmented to make the drawing visible. A wide range of oil-based media is available, but the durability of the image on the stone depends on the lipid content of the material being used, and its ability to withstand water and acid. Following the drawing of the image, an aqueous solution of gum arabic, weakly acidified with nitric acid, is applied to the stone. The function of this solution is to create a hydrophilic layer of calcium nitrate salt and gum arabic on all non-image surface zones. The gum solution penetrates into the pores of the stone or adheres to the surface of the metal plate, completely surrounding the original image with a hydrophilic layer that will not accept the printing ink. Using lithographic turpentine, the printer then removes any excess of the greasy drawing material, but a hydrophobic molecular film of it remains tightly bonded to the surface of the stone, rejecting the gum arabic and water, but ready to accept the oily ink. When printing, the stone is kept wet with water. Naturally the water is attracted to the layer of gum and salt created by the acid wash. Printing ink, including drying oils such as linseed oil and varnish loaded with pigment, is then rolled over the surface. The water repels the greasy ink, but the hydrophobic areas left by the original drawing material accept it. When the hydrophobic image is loaded with ink, the stone and paper are run through a press which applies even pressure over the surface, transferring the ink to the paper and off the stone. In this application, a low viscosity cellulose gum or carboxymethylcellulose and another tree exudate called Combretum have partially replaced gum arabic in some aqueous printing formulas; however, as it will be apparent in the proceeding disclosure, the disclosed compositional replacement is different.

Due to the uniqueness of gum arabic, related arts to replace it in various uses such as food, pharmaceutical and industrial applications are scarce. Therefore, there is a need for a replacement for gum arabic.

### SUMMARY OF THE INVENTION

Accordingly, the invention is directed towards gum arabic replacement, partial replacement or extending replacements and use of the same in various applications, e.g., food industry, pharmaceutical industry, and others, that substantially obviates one or more of the problems due to limitations and disadvantages of the related art.

An advantage of the invention is to provide gum arabic replacement using locally available materials that will reduce reliance on imported gum arabic.

Another advantage of the invention is to provide gum arabic replacement with competitive or lower cost structure than gum arabic.

Other advantages of the present invention are the added improvement in functionality in certain applications such as the whiter color, faster drying when used in panning and better film barrier and protection against oxidation.

Additional features and advantages of the invention will be set forth in the description which follows, and in part will be apparent from the description, or may be learned by practice of the invention. These features and other advantages of the invention will be realized and attained by the structure particularly pointed out in the written description and claims hereof as well as the appended drawings.

An embodiment of the invention is directed towards a method of preparing a gumarabic replacement, partial replacement or extending composition, for use in panning, candy, coating and adhesion applications. The method includes selecting a strong (key) film former of natural and/or modified polysaccharides that includes between approximately 0.1% and approximately 10% of a total composition, or used at a level in the finished application equivalent to about 0.1 to 10% of what gum arabic would typically be used regardless of whether the gum arabic is used.

Another embodiment of the invention is directed towards a method of using a gum arabic replacement, partial replacement or extending composition as an agent to bind and strengthen a sugar or sugar-alcohol shell coat, seal oil containing centers, strengthen candies and adhere seeds and cereal pieces. The method includes applying an aqueous gum arabic replacement, partial replacement or extending composition as an agent to bind and strengthen a sugar or sugar-alcohol shell coat, seal oil containing centers, strengthen candies and adhere seeds and cereal pieces together. The composition of this embodiment includes a strong (key) film former of natural and/or modified gum being about 0.1% to about 10% of a total composition, or used at a level in the finished application equivalent to about 0.1 to 10% of what gum arabic would typically be used regardless of whether gum arabic is used. Optionally, the composition further includes a low viscosity cracking agent, a tackiness modifier, and/or a fast-crystallizing agent. For example, a low viscosity cracking agent comprises between approximately 0% and approximately 99.9% of the total composition, or used at level in the finished application equivalent to about 0 to 99.9% of what gum arabic would typically be used regardless of whether the gum arabic is used. The tackiness modifier may make up between about 0% and approximately 10% of the total composition or used at level in the finished application equivalent to about 0 to 10% of what gum arabic would typically be used regardless of whether the gum arabic is used. The fast-crystallizing agent may account for between about 0% and about 99.8% of the total composition or used at level in the finished application equivalent to about 0 to 99.8% of what gum arabic would typically be used regardless of whether the gum arabic is used.

Yet another embodiment is directed towards a method of preparing a gum arabic replacement, partial replacement or extending composition as an encapsulating agent for spray-dried flavors or as an edible film. The method includes selecting a strong (key) film former of natural and/or modified polysaccharide that includes between approximately 0.1% and approximately 10% of the composition, or used at a level in the finished application equivalent to 0.1 to 10% of what gum arabic would typically be used regardless of whether gum arabic is used. The method also includes adding a natural and/or modified emulsifier that provides stable flavor emulsion for at least 4 to 6 hours from preparation, and wherein such natural and/or modified emulsifier can be an optional ingredient when replacing gum arabic in edible glitter, wherein such emulsifier includes about 0.1% to about 25% of the total composition, and wherein such natural and/or modified emulsifier can be an optional ingredient when replacing gum arabic in edible glitter. In addition, the method includes adding a low viscosity polysaccharide being about 50% to about 99.9% of the total composition, wherein the composition has a viscosity at concentrations of about 35-40° Brix of being about 10 cP to about 2000 cP at 25° C.

Still yet another embodiment of the invention is directed towards a method of using a gum arabic replacement, partial replacement or extending composition in a lithography or printing application. The method includes selecting an anionic polysaccharide being about 0.1% to about 10% of the total composition, wherein the anionic polysaccharide is selected from the group consisting of xanthan gum, cellulose gum, alginate, ghatti, karaya, and combinations thereof. The method further includes adding an emulsifier and surface-adhesion modifier being about 0.1% to about 25% of the total composition. The emulsifier and surface-adhesion modifier is selected from the group consisting of propylene glycol alginate, OSA modified gums, high efficacy gum Acacia emulsifier, tragacanth and combinations thereof. The method also includes adding a low viscosity solvent-resistant polysaccharide selected from the group consisting of maltodextrin, larch gum, inulin, polydextrose, and combinations thereof and being about 65% to about 99.8% of the total composition. The composition has a viscosity at a concentration of about 14° Baume of being about 10 cP to about 900 cP at 25° C.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1A illustrates a film cracking pattern of Acacia Seyal gum arabic according to an example of the invention;

FIG. 1B illustrates a film cracking pattern of Acacia Senegal gum arabic according to another example of the invention;

FIG. 2 illustrates a viscosity profile of gum arabic compositions in FIGS. 1A and 1B;

FIG. 3A illustrates a CMC or cellulose gum film according to another example of the invention;

FIG. 3B illustrates a methylcellulose gum film according to another example of the invention;

FIG. 3C illustrates a pectin film according to another example of the invention;

FIG. 3D illustrates an agar film according to another example of the invention;

FIG. 3E illustrates a sodium alginate film according to another example of the invention;

FIG. 3F illustrates a locust bean gum film according to another example of the invention;

FIG. 3G illustrates a xanthan gum film according to another example of the invention;

FIG. 3H illustrates a carrageenan film according to another example of the invention;

FIG. 4A illustrates an inulin film according to another example of the invention;

FIG. 4B illustrates a larch gum film according to another example of the invention;

FIG. 4C illustrates a low viscosity starch film according to another example of the invention;

FIG. 4D illustrates a maltodextrin film according to another example of the invention;

FIG. 5A illustrates a film cracking pattern of Replacement 1 Std. according to another example of the invention;

FIG. 5B illustrates a film cracking pattern of Replacement 1 All Natural according to another example of the invention;

FIG. 6 illustrates viscosity profiles according to another example of the invention;

FIG. 7 illustrates three different films having different flake patterns according to another example of the invention;

FIG. 8A illustrates an Acacia Seyal gum arabic film having a flake pattern according to another example of the invention;

FIG. 8B illustrates a 50:50 blend of Acacia Seyal:Acacia Senegal gum arabic film having a flake pattern according to another example of the invention;

FIG. 8C illustrates an Acacia Senegal film having a flake pattern according to another example of the invention;

FIG. 8D illustrates an Acacia Seyal Replacement 1 Std. film having a flake pattern according to another example of the invention;

FIG. 8E illustrates an Acacia Seyal film having a flake pattern according to another example of the invention;

FIG. 8F illustrates an Acacia Senegal film having a flake pattern according to another example of the invention;

FIG. 8G illustrates an Acacia Senegal film having a flake pattern according to another example of the invention;

FIG. 8H illustrates a Replacement 1 Fast film having a flake pattern according to another example of the invention;

FIG. 81 illustrates a Replacement 1 All Natural film having a flake pattern according to another example of the invention;

FIG. 9A illustrates an Acacia Seyal edible glitter according to an example of the invention;

FIG. 9B illustrates a Replacement 2 with OSA-modified gum edible glitter according to another example of the invention; and

FIG. 9C illustrates Replacement 2 All Natural emulsifier edible glitter according to another example of the invention.

### DETAILED DESCRIPTION OF THE ILLUSTRATED EMBODIMENTS

Embodiments of the invention are directed towards gum arabic replacements for use in three major categories of applications including: (1) panning, confections, food and pharmaceutical adhesion and coating; (2) flavor encapsulation/spray dried flavors and edible films; and (3) lithography or printing applications. Of course gum arabic replacement, partial replacement or extending composition may be used for a number of other applications, e.g., food, pharmaceutical and industrial applications. Embodiments are also directed towards replacements for gum arabic that use locally available materials for major and minor users such as the chewing gum, confection, flavor encapsulation, edible film, and lithography industries, thereby minimizing cost and shortage concerns.

The nature of gum arabic lies between that of materials that can generate continuous films and materials that cannot generate continuous films. Embodiments of the invention, through the manipulation of key components such as strong film formers, cracking agents, fast crystallizing agents and emulsifiers, permit formation of materials that lie anywhere between these two film forming extremes.

Embodiments of the invention also consider parameters or characteristics of gum arabic, such as film forming capability, low viscosity, sugar binding properties, effect on drying times, crystallization patterns, level of tackiness, and crunch. While these parameters or characteristics of gum arabic provide good performance in end-use applications, improvements in specific characteristics such as drying time, shell strength, crunch, and optimized tackiness are also desired. Moreover, issues concerning cracking during transportation of end products create a demand for an anti-cracking or anti-chipping gum arabic replacement.

The choice for the use of gum arabic for sealing nuts, chocolate, malt balls and other oil containing centers intended for panning also stems from its uniquely low viscosity that makes it possible to apply it as a coating syrup at 40% and from its film forming property that acts both as an oil barrier to seal oil and as an oxygen barrier to prevent oxidation and rancidity. Gum arabic is also tacky and adhesive at high concentrations, which makes it suitable for adhesion of seeds, cereal clusters, granola bars and related products. It leaves a shiny film when used as a polish for chocolate panned confections, when coated on tablets or when sprayed over chocolate bars and other candies. Gum arabic is also used in pastilles and other hard candies to increase strength and reduce the brittleness of crystallized sugar candies.

Gum arabic is also traditionally used in flavor encapsulation or spray dried flavors to protect flavor oils from oxidation. Although it is not nearly as good a film former as compared to most other gum polysaccharides, gum arabic's low viscosity is ideal as the film former in this application because it makes it possible to load the recipe with high solids (meaning less water to dry) with minimal increase in viscosity of the emulsion for spray drying. At the same time, the theory of encapsulation requires an optimum ratio of 4 parts of encapsulating material for 1 part of oil to be encapsulated and this makes other gums with significantly better film forming properties unsuitable due to extreme viscosity build up even at much less than the optimum usage of 4:1. In flavor encapsulation, there is one other property of gum arabic that is required in addition to its film forming and low viscosity—its emulsifying property. Both grades of gum arabic, Acacia Seyal and Acacia Senegal, have been shown to work comparably in this application confirming that even though Acacia Seyal does not produce a stable beverage emulsion due to its weaker emulsifying property, it is good enough to emulsify flavor emulsions meant to be spray dried. Therefore, to replace gum arabic in this application, an emulsifier is a required ingredient in the composition that is not required in the previously described applications.

The cracking pattern of gum arabic when its solution of about 40% is cast and dried on a surface (normally a stainless steel belt) is perfect for its use in edible film glitter. Again the weak film and the low viscosity are critical properties; additionally, the clarity, sheen, adhesion property when wet and ease of release when the film dries are equally important quality attributes of gum arabic in this application.

In lithography, the main function of gum arabic in the aqueous solution is to create a hydrophilic layer of calcium nitrate salt and gum arabic on all non-image surface zones. Therefore, properties of gum arabic that are critical in lithography include complete solubility and stability in the aqueous solution, surface adhesion/wetting and film forming.

Embodiments of the invention are directed towards preparing a gum Arabic replacement, partial replacement or extending composition, for use in variety of different applications. The gum arabic replacement, partial replacement or extending composition follows a two phase protocol. The two phase protocol includes Phase 1 and Phase 2. Phase I is directed towards studying gum arabic properties such as viscosity, film forming characteristics, coating, sheen, crystallization, cracking and solubility. Phase 2 is directed towards testing of gum arabic replacement, partial replacement or extending composition in specific end uses, such as food, pharmaceutical and industrial applications.

Referring now to Phase I, basic gum arabic studies of viscosity, film forming, coating, sheen, crystallization, cracking and solubility in water and high Brix syrups were conducted. Various concentrations of gum arabic, both Acacia Seyal and Acacia Senegal, between about 10-50% were prepared and viscosity measured.

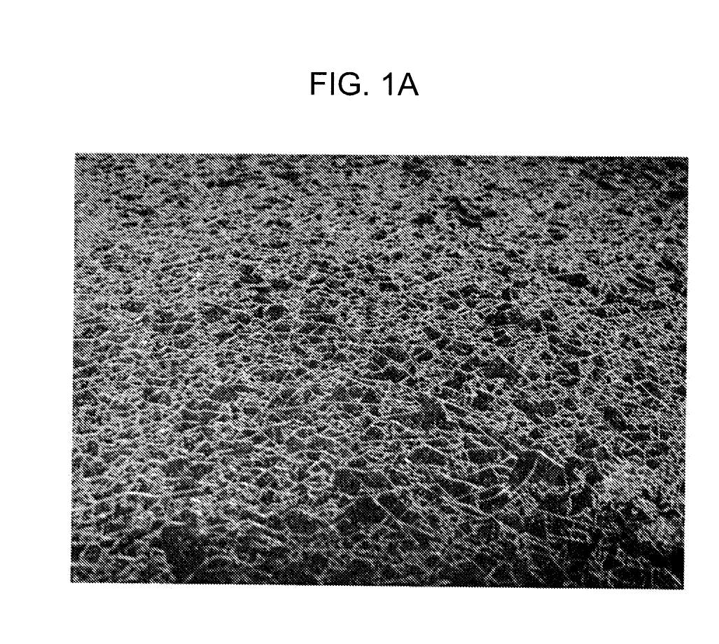

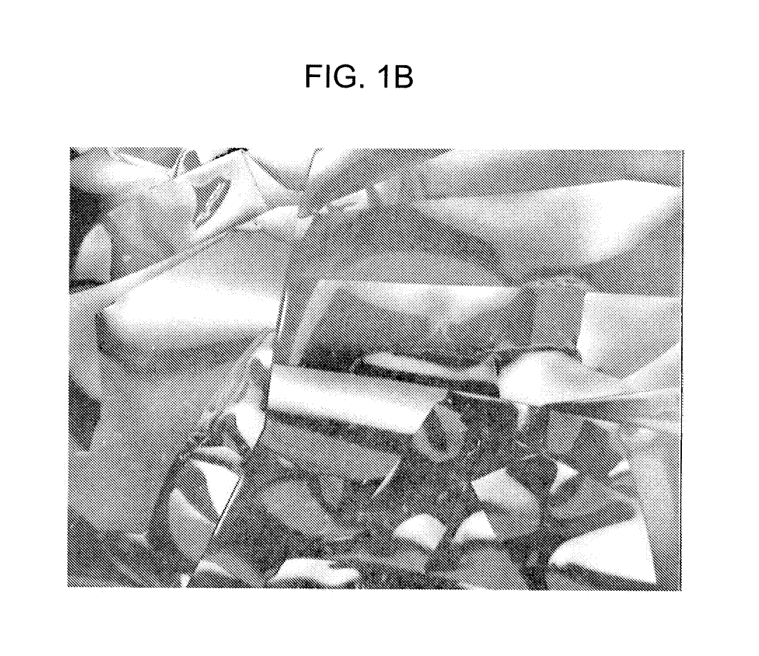

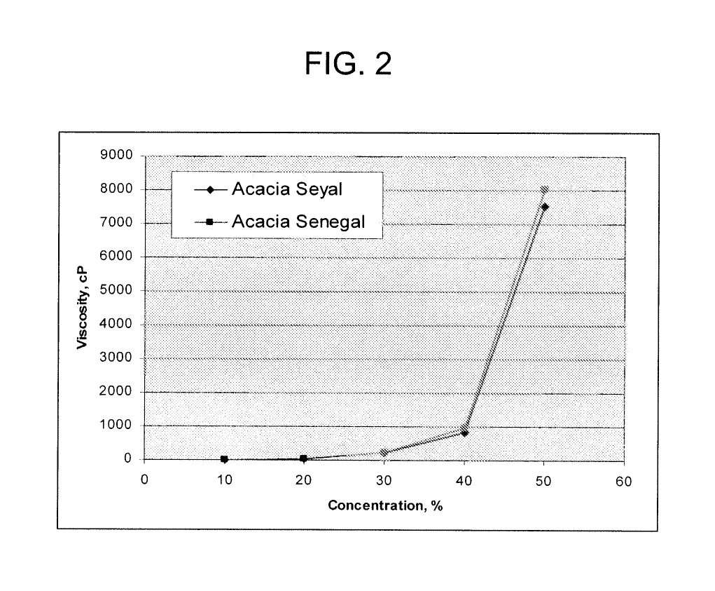

FIG. 1A illustrates a film cracking pattern of Acacia Seyal gum arabic. FIG. 1B illustrates a film cracking pattern of Acacia Senegal gum Arabic. FIG. 2 illustrates a viscosity profile of the gum arabic compositions in FIGS. 1A and 1B.

Referring to FIG. 1A, a cracking pattern was formed with an Acacia Seyal gum arabic water-in-water (w/w) emulsion. The composition was about a 35% w/w, i.e., Acacia Seyal gum arabic syrup. This composition was cast at 10 mils thickness on a glass plate between about 10 to 40 mils in thickness, dried, and observed for crystallization and cracking patterns. The resulting film formed a cracking pattern shown in FIG. 1A.

Referring to FIG. 1B, a cracking pattern was formed with an Acacia Senegal gum arabic water-in-water (w/w) emulsion. The composition was about a 35% w/w, i.e., Acacia Senegal gum arabic syrup. This composition was cast at 10 mils thickness on a glass plate between about 10 to 40 mils in thickness, dried, and observed for crystallization and cracking. The resulting film formed a cracking pattern shown in FIG. 1B.

Comparing FIGS. 1A and 1B, there is a significant difference between the patterns, such as a difference in the number of cracks and size of flakes between the Seyal and the Senegal, the former producing numerous cracks and small flakes and the latter producing fewer cracks and larger size flakes.

FIG. 2 illustrates a viscosity profile of gum arabic compositions in FIGS. 1A and 1B. Referring to FIG. 2, it illustrates a hydration and viscosity of gum arabic in water at different concentrations, the profiles for Seyal and Senegal closely match each other. Individual gums were also studied the same way for film forming or cracking, changing concentrations as needed depending on viscosity. From the results of this study, it was determined that a single component gum arabic replacement was not able to match the attributes of gum arabic in these evaluations.

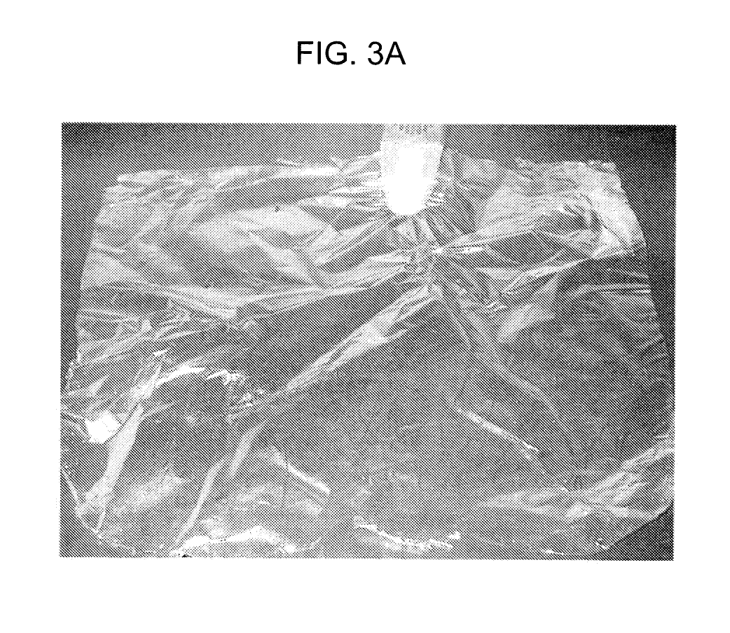

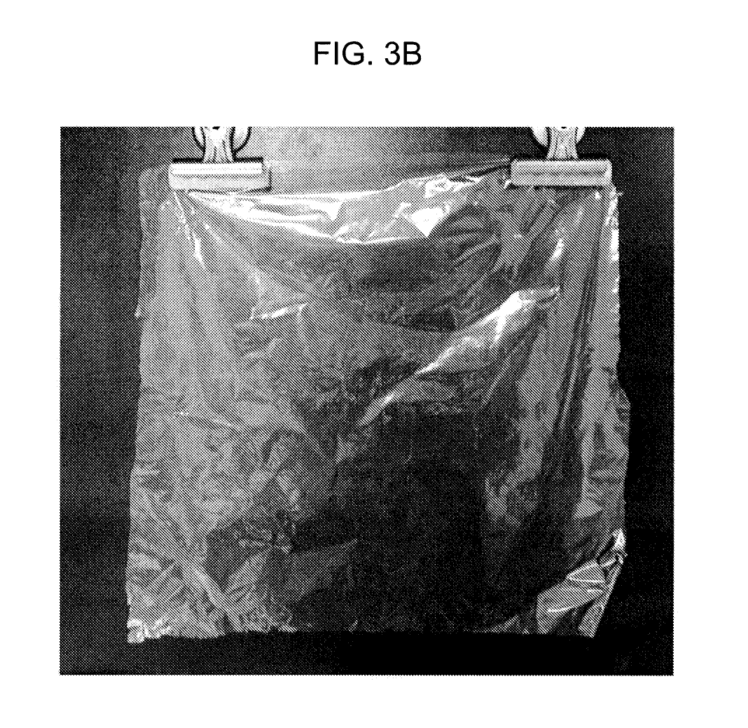

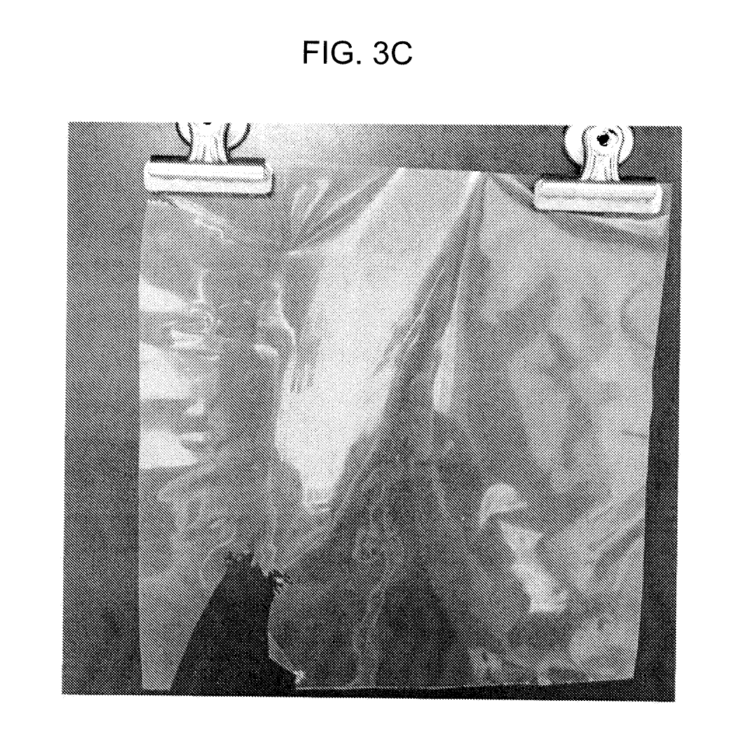

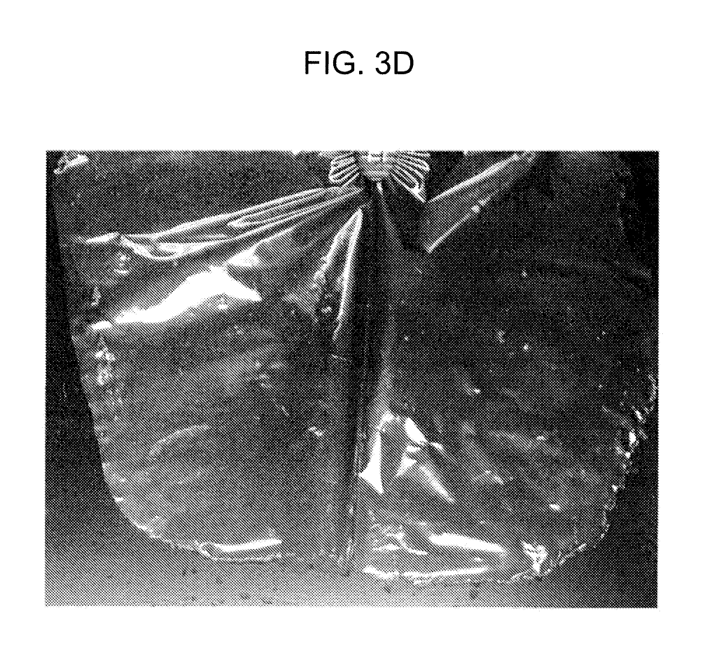

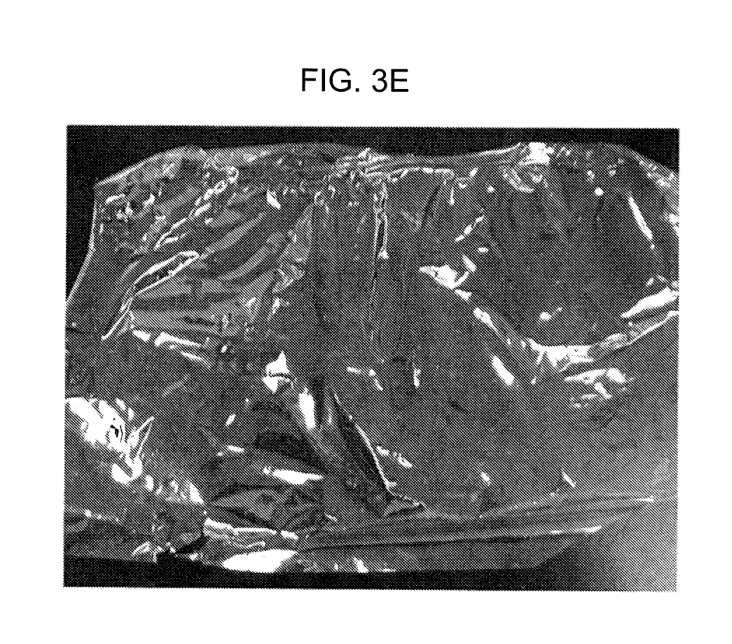

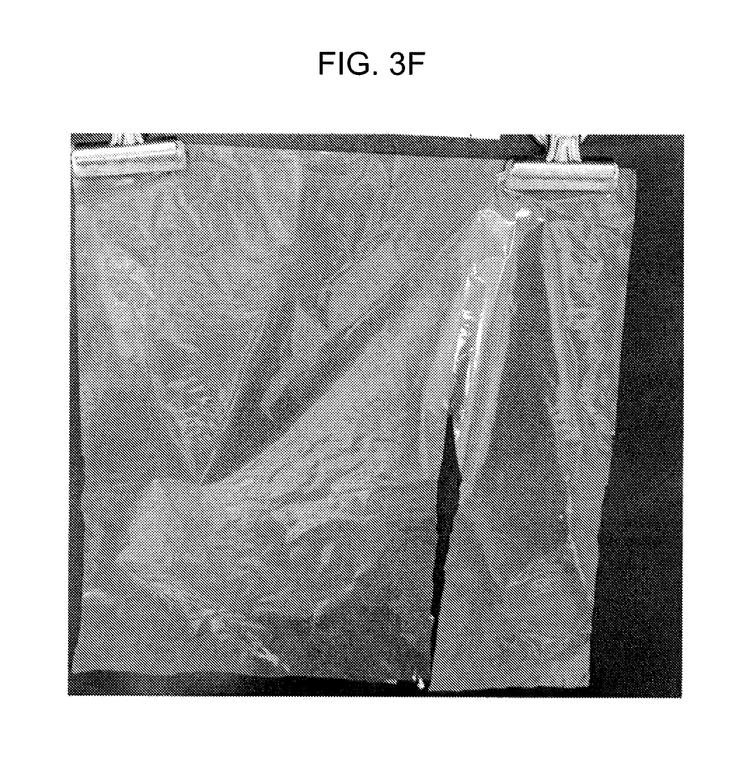

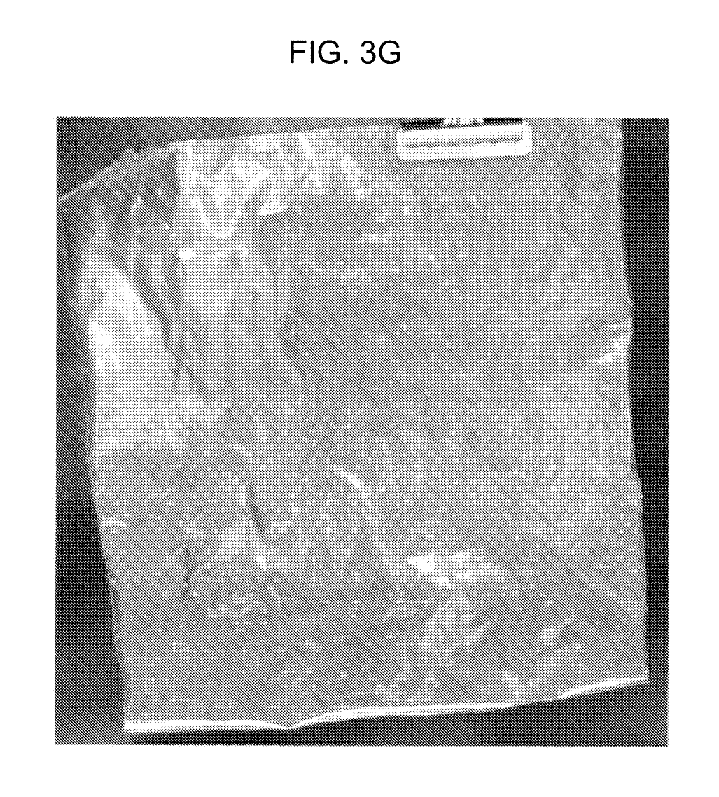

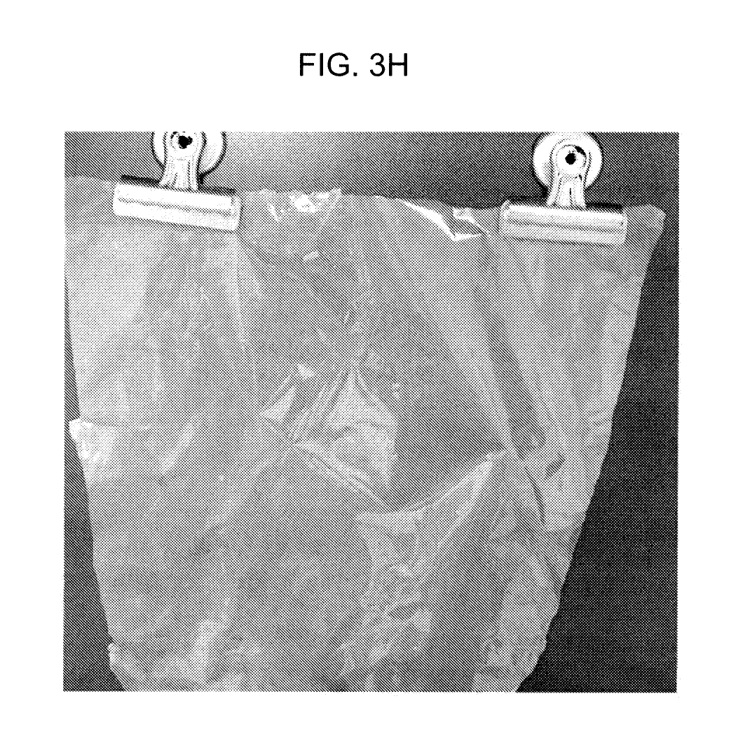

FIG. 3A illustrates a CMC or cellulose gum film according to another example of the invention. FIG. 3B illustrates a methylcellulose gum film according to another example of the invention. FIG. 3C illustrates a pectin film according to another example of the invention. FIG. 3D illustrates an agar film according to another example of the invention. FIG. 3E illustrates a sodium alginate film according to another example of the invention. FIG. 3F illustrates a locust bean gum film according to another example of the invention. FIG. 3G illustrates a xanthan gum film according to another example of the invention. FIG. 3H illustrates a carrageenan film according to another example of the invention.

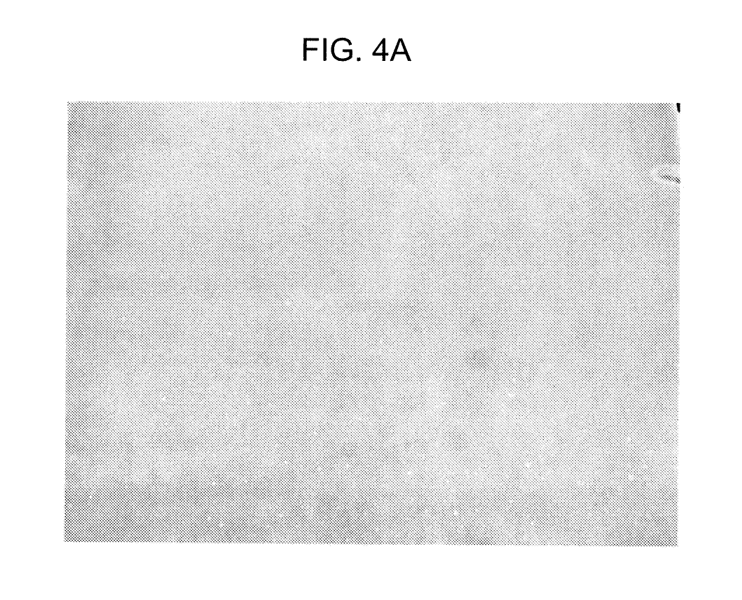

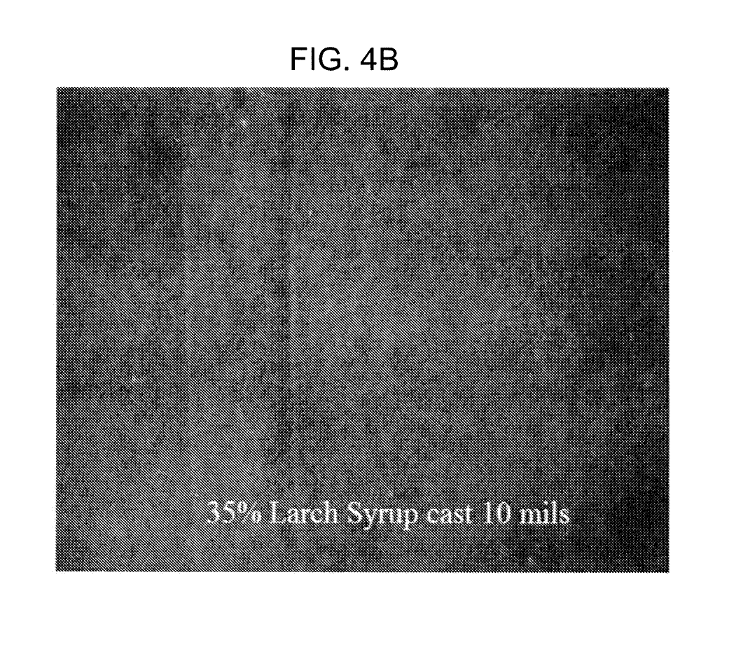

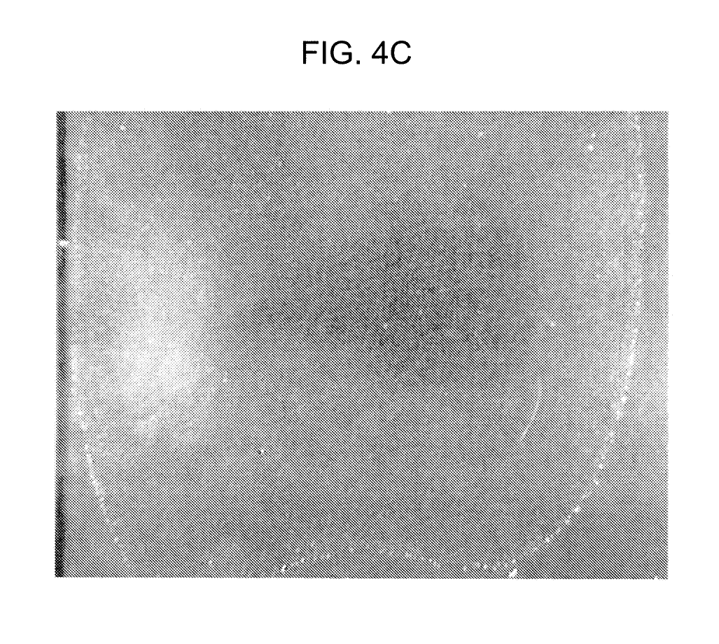

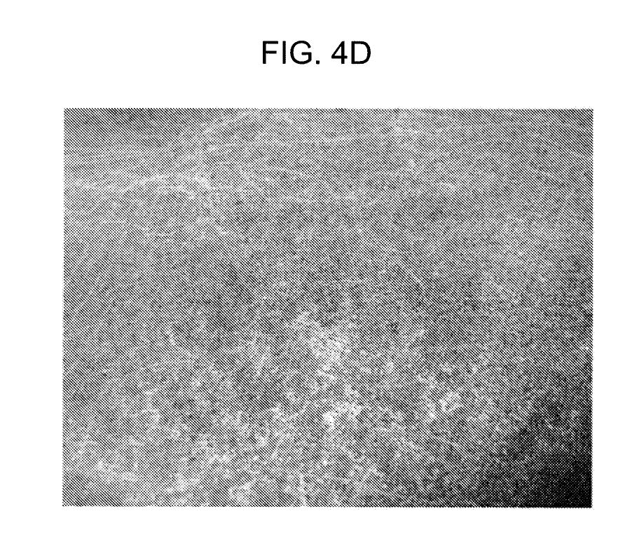

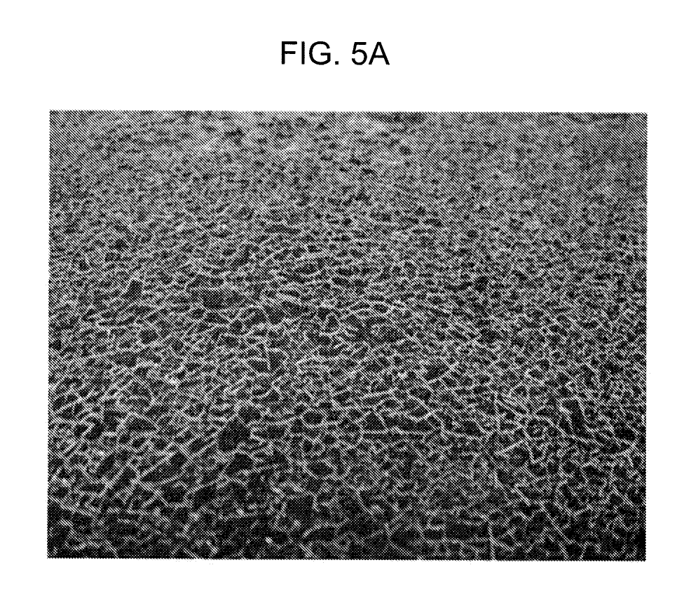

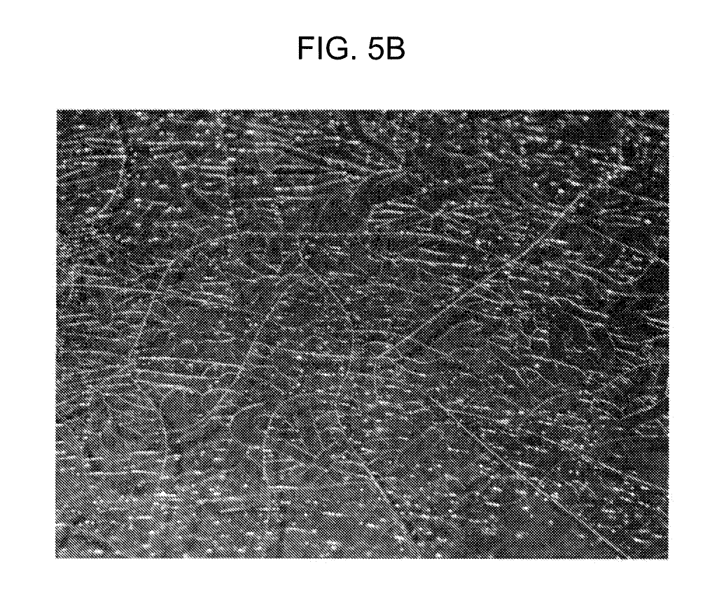

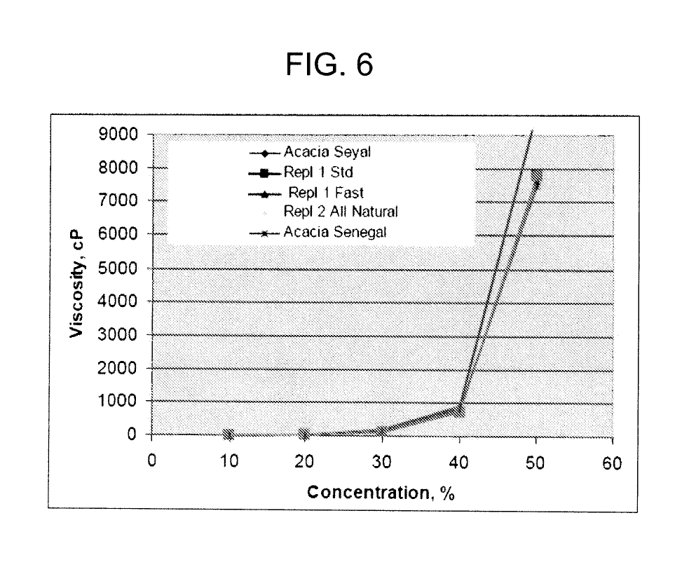

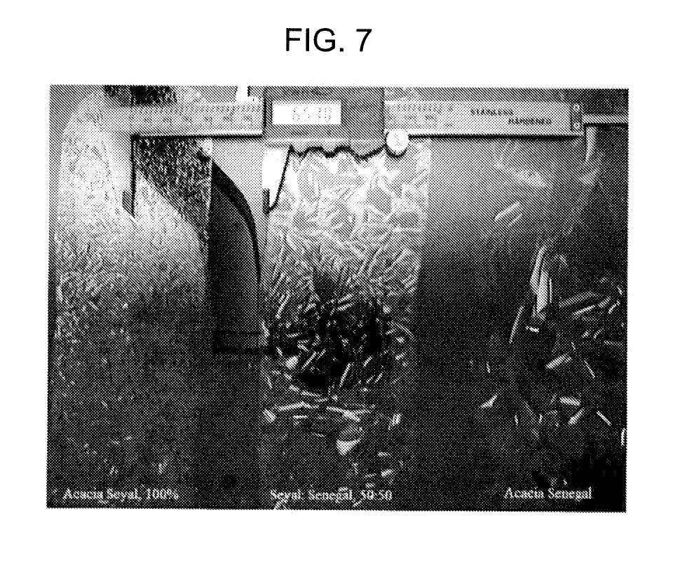

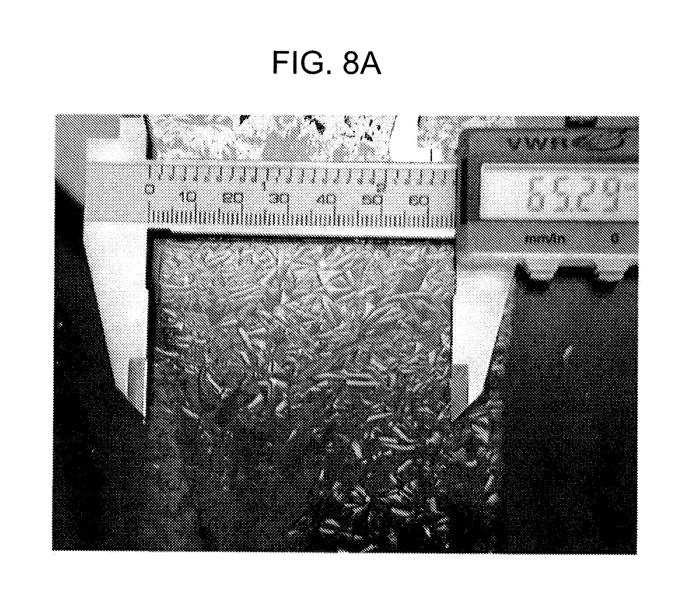

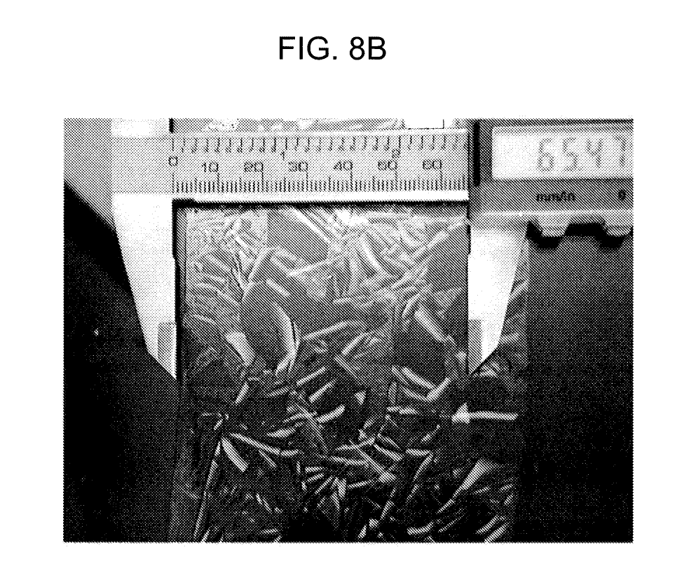

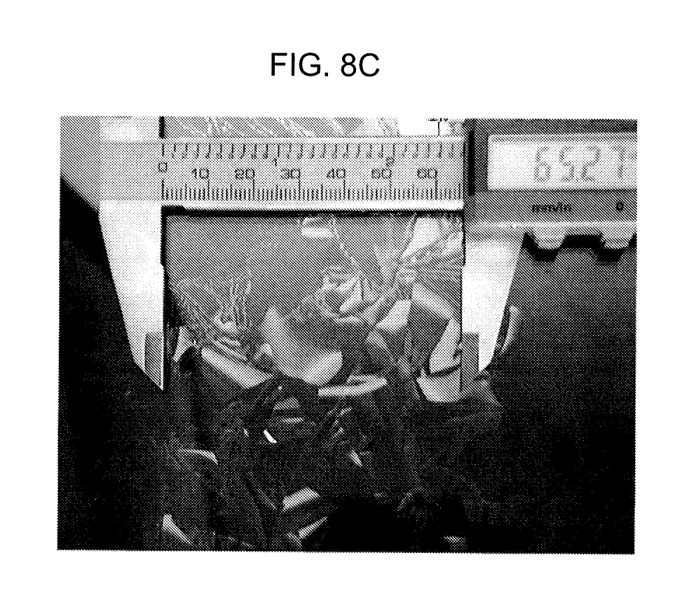

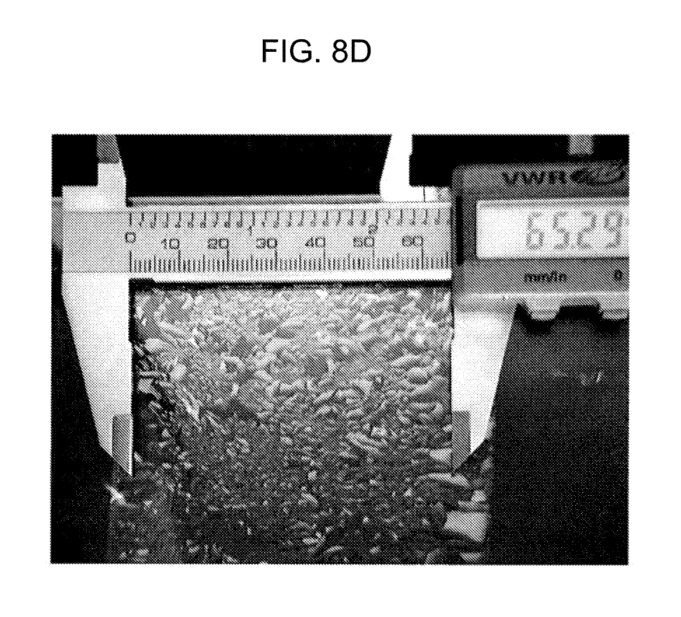

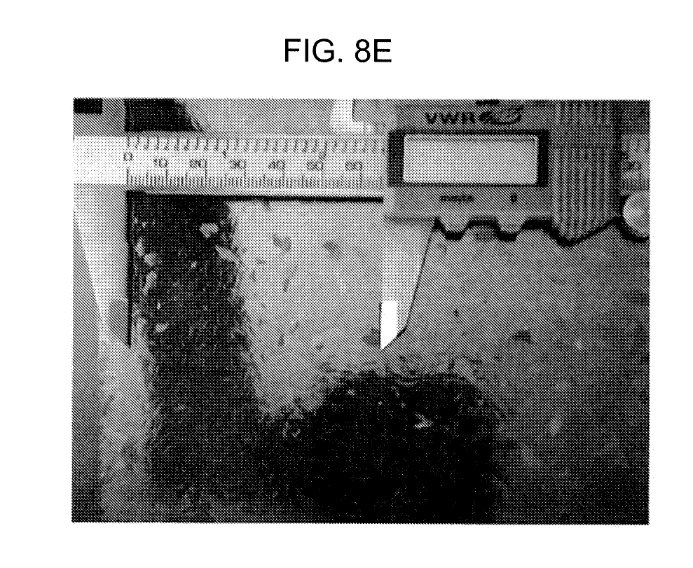

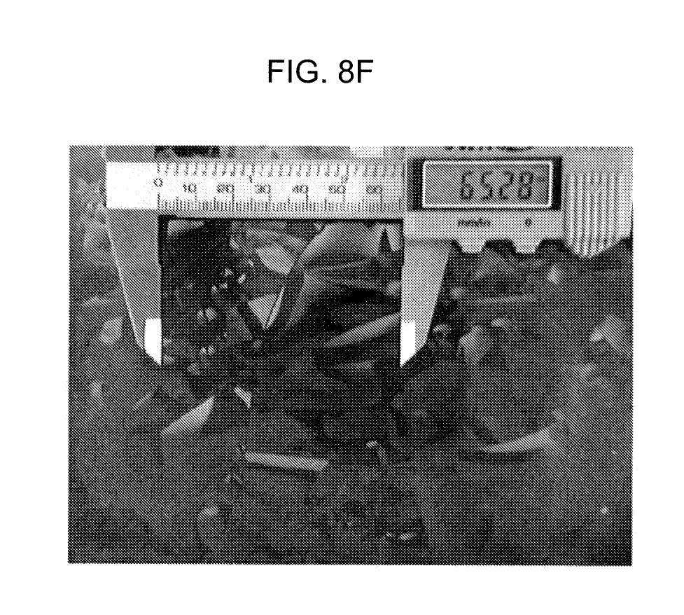

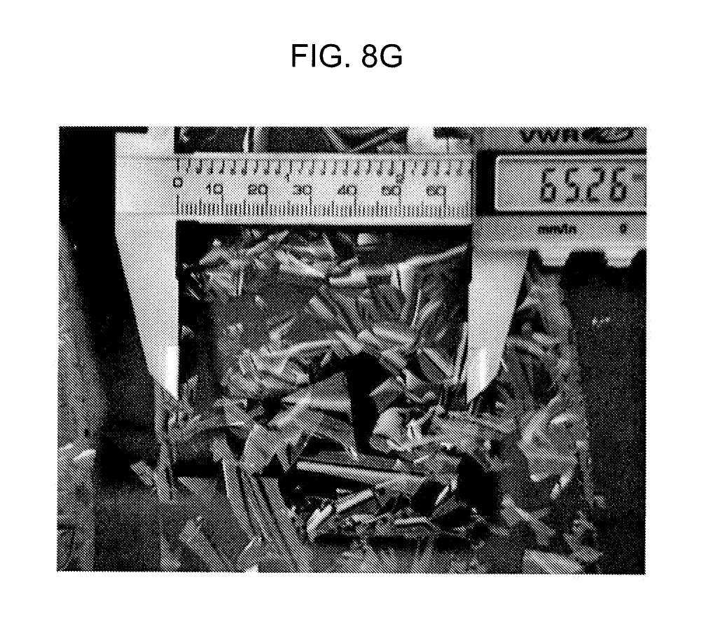

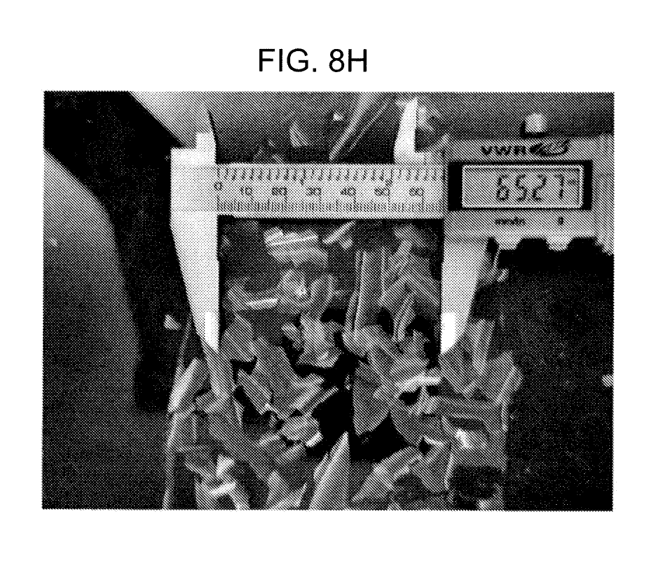

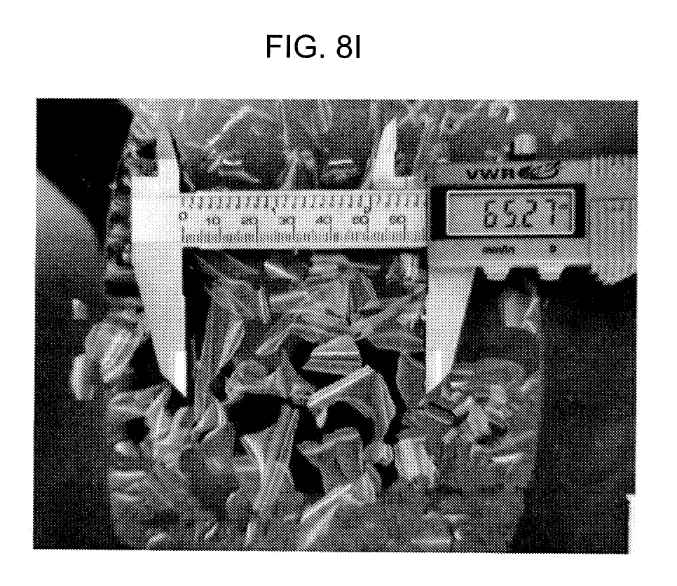

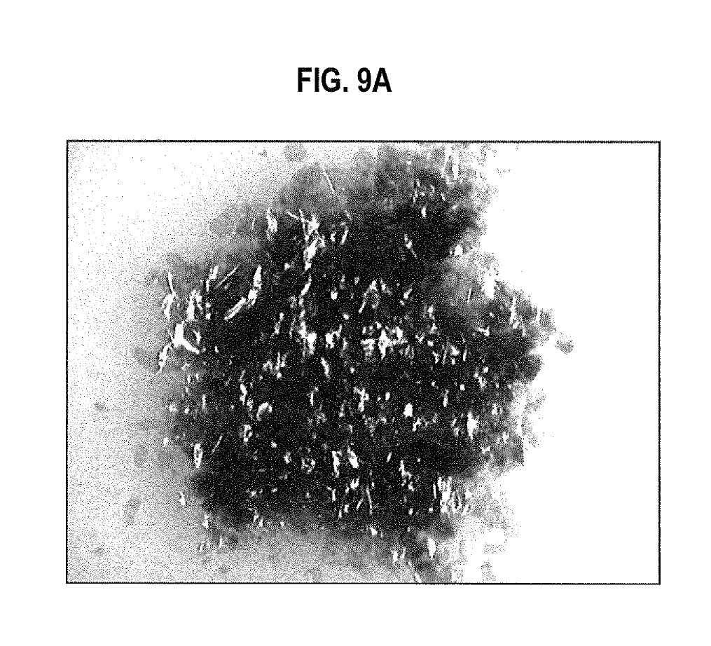

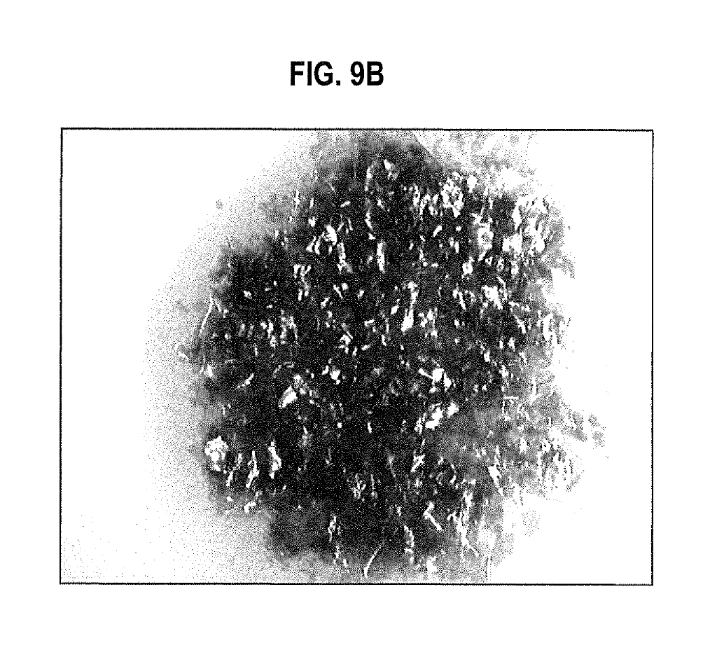

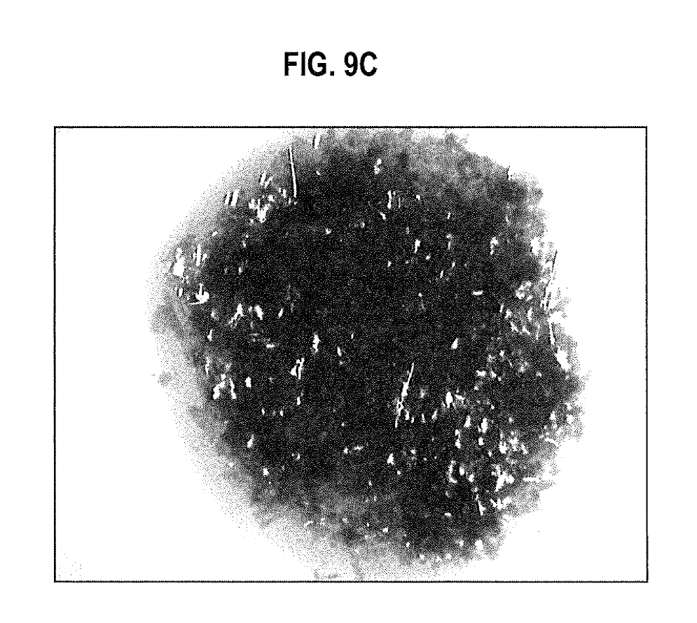

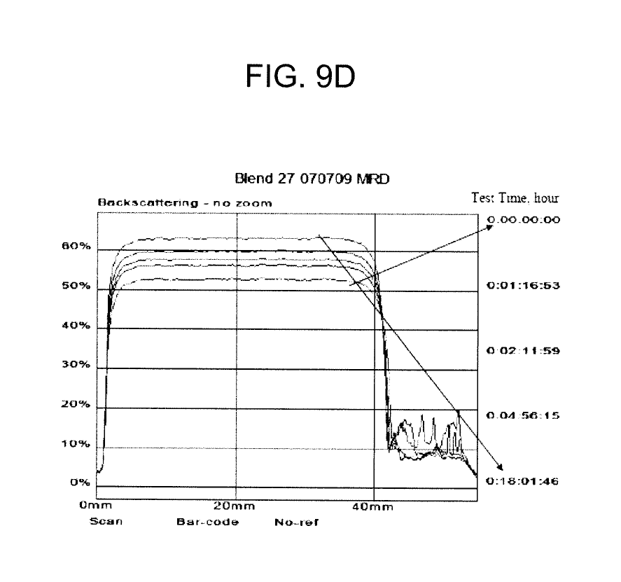

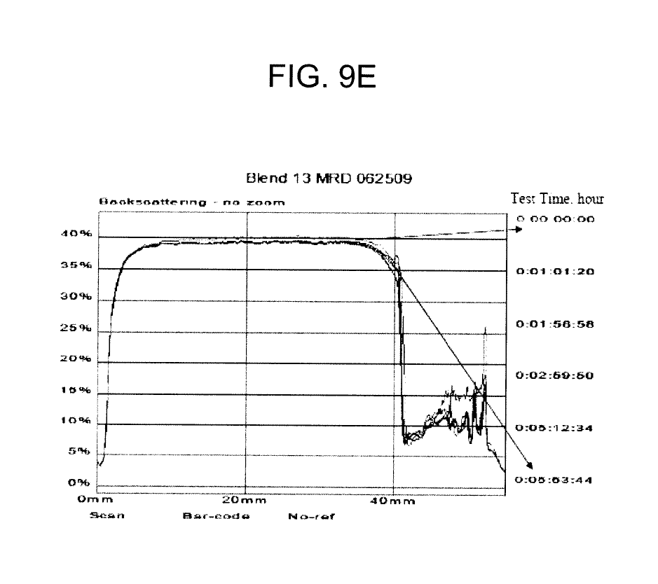

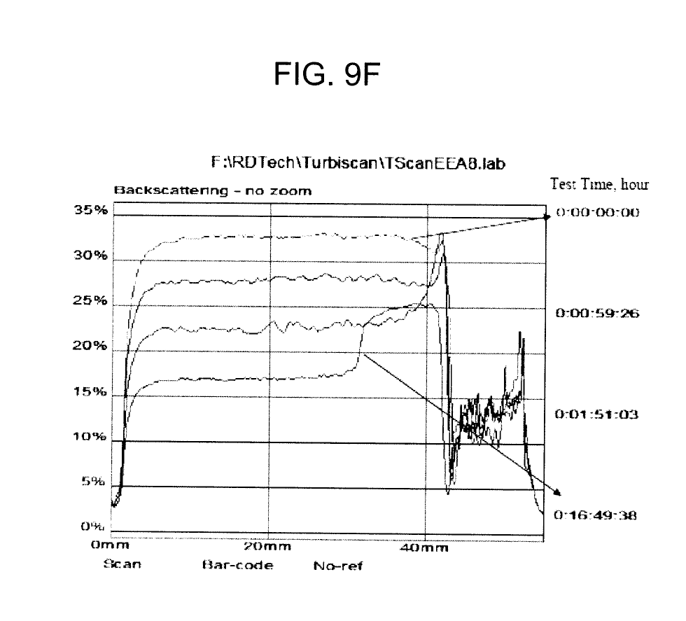

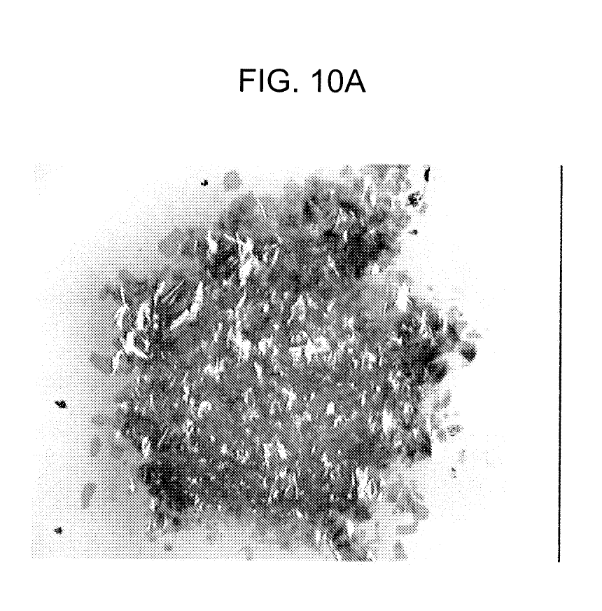

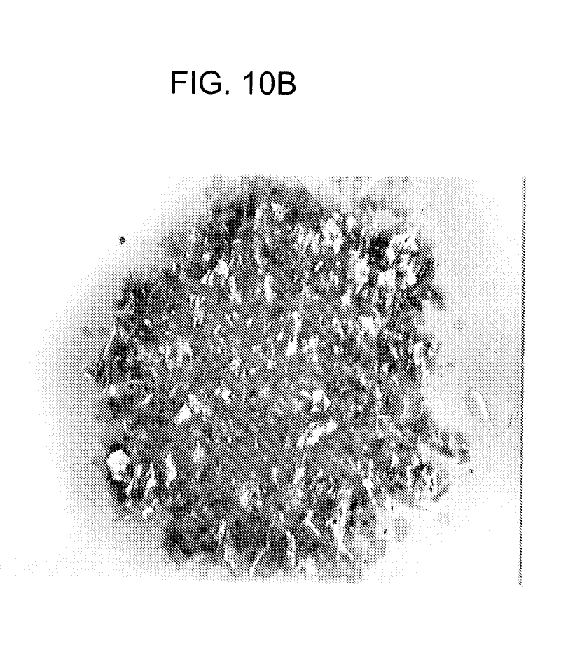

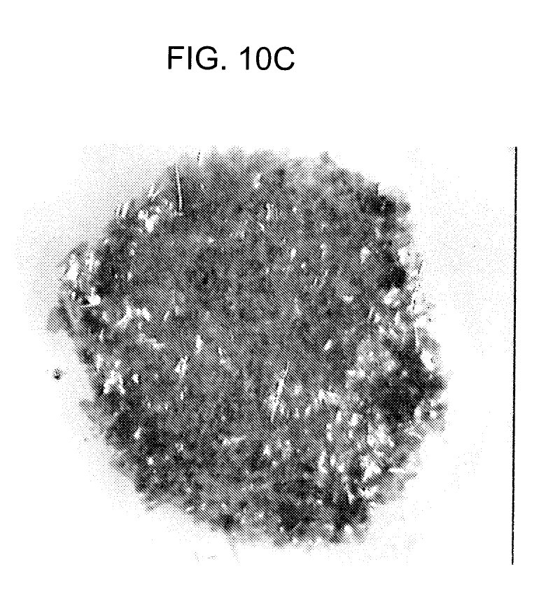

FIG. 4A illustrates an inulin film according to another example of the invention. FIG. 4B illustrates a larch gum film according to another example of the invention. FIG. 4C illustrates a low viscosity starch film according to another example of the invention. FIG. 4D illustrates a maltodextrin film according to another example of the invention.

Now referring to FIGS. 3A-4D, various properties and features can be illustrated. That is, FIGS. 3A-3H are a representation of the film forming properties of food grade gum polysaccharides prepared at suitable concentrations for casting including that of a maltodextrin film and low viscosity starch film as shown in FIGS. 4C and 4D, respectively.

From these results, it was discovered that no other material alone will replace gum arabic and that a replacement (or replacements) depending on application, can only be achieved with a carefully designed composition. Also, it is shown that the wide range of polysaccharides studied that do not form a film and turned powdery when scraped, as in the case of inulin film (FIG. 4A) and 15 DE maltodextrin film (FIG. 4D), to those that form a strong cohesive film that peels off in one piece after casting and drying, such as cellulose gum film (FIG. 3A), methylcellulose film (FIG. 3B), pectin film (FIG. 3C), agar film (FIG. 3D), sodium alginate film (FIG. 3E), locust bean gum film (FIG. 3F), xanthan film (FIG. 3G) and carrageenan film (FIG. 3H) among others. It was discovered that required elements to replace gum arabic, either Acacia Seyal and Acacia Senegal, in various applications include: (1) a strong (key) film former, that is required in all applications at some minimum level, and the addition of (2) a low viscosity cracking ingredient, and/or (3) an emulsifier and/or (4) a tackiness modifier, and/or (5) a fast-crystallizing ingredient; each may be required dependent on the finished application.

From a number of compositions studied with competitive or better cost structure than gum arabic, the end result is three methods of replacement that produce replacement compositions that are functionally equivalent to gum arabic in three major categories of applications. These are: (1) Replacement Method 1 is targeted for use in, but not limited to, sugar and sugar-free panning, confections, adhesion and coating applications; (2) Replacements Method 2 is a gum arabic replacement more suited for flavor encapsulation/spray dried flavors and edible film and glitters applications, although they will also work in panning and confections applications, and; (3) Replacement Method 3 is a gum arabic replacement more suited for, but not limited to, lithographic/printing applications that is functionally equivalent to gum arabic in wetting and oil/ink-repelling properties.

Method 1 generates replacement compositions:
1. selecting a strong (key) film former chosen from a list of natural and modified polysaccharides including, but not limited to, carrageenan, pectin, alginate, gellan, agar, konjac, xanthan, guar, locust bean gum, tara, fenugreek, starch, cellulose gum, methyl cellulose, HPMC, propylene glycol alginate, or a combination thereof at approximately 0.1% to 10% when replacing gum arabic or used at a level in the finished application equivalent to about 0.1 to 10% of what gum arabic would typically be used (regardless of whether gum arabic is used), where such key film formers may vary in molecular weights and viscosities;
2. as needed to improve functionality, a low viscosity cracking ingredient that standardizes the viscosity, modifies the crystallization and cracking pattern of the key film former in 1 above including, but not limited to, maltodextrin, monosaccharides, disaccharides, oligosaccharides, larch gum, polydextrose, or a combination thereof, that is chosen depending on if the application is sugar-free or not and where such ingredient, or combination thereof, may be used at concentrations from 0% to 99.9%;
3. as needed to improve functionality over that of Acacia Seyal or to match Acacia Senegal, adding a fast-crystallizing ingredient that may also serve the role as a cracking agent consisting of, but not limited to, inulin, erythritol, low DE maltodextrin, lactose, or a combination thereof, used at 0% to 99.9%; and
4. as needed to improve functionality in a panning application, adding a tackiness modifier consisting of, but not limited to, starch, guar gum, locust bean gum, or a combination thereof, at approximately 0% to 10%, where such ingredient may vary in molecular weights and viscosities.

Method 2 generates replacement compositions:
1. Selecting a strong (key) film former chosen from a list of natural and modified polysaccharides including, but not limited to, carrageenan, pectin, alginate, gellan, agar, konjac, xanthan, guar, locust bean gum, tara, fenugreek, starch, cellulose gum, methyl cellulose, HPMC, propylene glycol alginate, or a combination thereof at approximately 0.1 to 10% when replacing gum arabic or used at a level in the finished application equivalent to about 0.1 to 10% of what gum arabic would typically be used (regardless of whether gum arabic is used), where such key film former may vary in molecular weights and viscosities;
2 adding an emulsifier such as propylene glycol alginate, emulsifying starch, OSA-modified gums, mono- and diglycerides, soy lecithin, proteins or a combination thereof, at approximately 0.1% to 25%; and
3. adding a low viscosity polysaccharide such as maltodextrin, larch gum, polydextrose, inulin, or a combination thereof, used at concentrations from 50% to 99.9%, and to achieve a drop-in usage as gum arabic or a reduction in usage in some non-sensitive applications with equivalent functionality as gum arabic.

Method 3 generates gum arabic replacement compositions:
1. selecting an anionic polysaccharide such as, but not limited to, xanthan gum, cellulose gum, carrageenan, alginate, ghatti, karaya, or a combination thereof, at approximately 0.1% to 10%;
2. adding an emulsifier and surface-adhesion modifier such as propylene glycol alginate, OSA-modified gums, high efficacy gum acacia emulsifier, soy lecithin or a combination thereof, at approximately 0.1% to 25%; and
3. adding a low viscosity solvent-resistant polysaccharide such as maltodextrin, larch gum, inulin, polydextrose, or a combination thereof, at approximately 65% to 99.8%.

Phase 2 involved testing of the gum arabic replacement compositions in specific end uses, such as: (1) Method 1 replacements compositions referred to as Replacement 1 Std. as a match to Acacia Seyal, Replacement 1 Fast and Replacement 1 all natural were used in sugar-free panning of chewing gums, sealing and regular sugar panning of peanuts, as well as in pastilles; (2) Method 2 replacement compositions labeled Replacements 2 were tested in flavor encapsulation and film glitter applications; and (3) Method 3 replacement compositions labeled as Replacements 3 were tested in the aqueous phase of the lithographic solution for stability.

Table 1 was prepared and includes size of flakes for a 40° Brix Acacia Seyal, Acacia Senegal, Seyal-Senegal blend and gum Replacements from Method I cast at 5 and 10 mils thickness.

TABLE 1

| Gum System | Width, mm | Length, mm |
|---|---|---|
| Acacia Seyal, 100% | 0.5-3 | 1.0-10 |
| Acacia Seyal/Senegal, 50:50 | 3-10 | 4-30 |
| Acacial Senegal, 100% | 5-23 | 10-60 |
| Replacement 1 | 0.5-3 | 1.0-10 |
| Replacement 1 Fast | 5-30 | 10-70 |
| Replacement 1 Fast All | 3-20 | 10-40 |
| Natural | | |

Sugar-Free Chewing Gum Panning Example: In this example, gum arabic was compared to Replacement 1 Std. and Replacement 1 Fast. The sugar-free syrup recipe included 64.5% maltitol, 3.5% binder (gum arabic control or the gum arabic Replacements) and 32% water. The gums were first added to the water and heated to about 82° C., before the maltitol powder was added. Then the syrups were brought to a boil, adjusted to 70° Brix, 68° Brix and 60° Brix for viscosity measurements at 60° C. and 25° C. Using an 18 inch diameter pan coater, the 60° Brix syrups containing gum arabic or the replacements were used in panning and compared for stickiness/tackiness and drying characteristics. The finished chewing gums with about 32.4 to 32.6% shell coat were equilibrated in the humidity chamber for about 16 hours at 35° C. and 12% RH and were tested for shell strength using the TA XT Plus Texture Analyzer, needle probe, 1 mm/sec test speed on 50 pieces of chewing gums as replications.

Viscosities of the sugar-free syrups are all in line with each other for gum arabic and the replacements as shown in Table 2. Table 2 illustrates syrup viscosities of maltitol syrups containing gum arabic and the replacements at application temperatures of 25° C. and 60° C. and various Brix values. Also, it was found that higher syrup viscosity may contribute to the centers sticking together and a bumpy surface and are, hence, undesirable. The different Replacement compositions were, therefore, all standardized to give the same viscosity and tackiness as the gum arabic, except in Replacement 1 Fast where tackiness is reduced for ease of panning.

TABLE 2

| | Average Viscosity | | | Average Viscosity | | |
|---|---|---|---|---|---|---|
| | at 25° C., cP | | | at 60° C., cP | | |
| Gum System | 70°Brix | 68°Brix | 60°Brix | 70°Brix | 68°Brix | 60°Brix |
| Acacia Seyal | 511 | 340 | 87 | 73 | 59 | 27 |
| Repl. 1 Std. | 531 | 374 | 98 | 77 | 59 | 28 |
| Repl. 1 Fast | 514 | 460 | 96 | 89 | 70 | 29 |
| Repl. 1 All | 460 | 350 | 92.5 | 60 | 54 | 29 |
| Natural | | | | | | |

Table 3 includes experimental batch records of sugar-free chewing gum panning using an 18 inch pan coater (batch size of 1000 g; dusting powder is maltitol; syrup temperature at a temperature of 60° C.; center size is 1.0 cm×2.1 cm; drying time after free flow was 2.5 minutes). Table 4 includes experimental batch records of sugar-free chewing gum panning using an 18 inch pan coater (batch size of 700 g; dusting powder is maltitol; center size is 1.2 cm x 1.9 cm; drying time after free flow is 2.5 minutes). As shown in Tables 3 and 4, Replacement 1 Std. shows the same drying time as the gum arabic. Replacement 1 Fast, which contains a fast-crystallizing ingredient, showed faster drying per syrup charge demonstrating that, as needed, the crystallization and drying of the panning syrup based on the standard replacement composition can be manipulated and improved over that of gum arabic. With a process as time consuming as panning, shorter drying per charge is desirable which is estimated to be in the magnitude of between 5-10% faster using an open pan coater. At the same time, an improvement in the color is achieved using the replacements that were both whiter in color. Gum arabic has a natural brownish pigment that shows in the shell coating especially if the chewing gums are panned without color.

TABLE 3

| | | | | Maltitol-Gum | | | | Maltitol-Repl. 1 | |
|---|---|---|---|---|---|---|---|---|---|
| | | | | Arabic Syrup | | Maltitol-Repl. 1 | | Fast Syrup | |
| | | | Mix Time | Air to | | Std. Syrup | | Air to | |
| | Syrup | Mix Time | Dusting | Free Flow, | Cycle Time, | Free Flow, | Cycle Time, | Free Flow, | Cycle time, |
| Charge # | wt, g | After Syrup | Powder | min | min | min | min | min | min |

Precoat/Gumming

| | | | | | | | | | |
|---|---|---|---|---|---|---|---|---|---|
| 1 | 12.5 | 1 | 1 | x | 5.50 | x | 5.50 | x | 5.50 |
| 2 | 12.5 | 1 | 1 | x | 5.50 | x | 5.50 | x | 5.50 |
| 3 | 12.5 | 1 | 1 | x | 5.50 | x | 5.50 | x | 5.50 |
| 4 | 12.5 | 1 | 1 | x | 5.50 | x | 5.50 | x | 5.50 |
| 5 | 12.5 | 1 | 1 | x | 5.50 | x | 5.50 | x | 5.50 |

Engrossing [Same conditions up to 25 charges of syrup]

| 6 | 6.25 | 1 | x | 2.5 | 5.00 | 2.5 | 5.00 | 2.5 | 5.00 |
|---|---|---|---|---|---|---|---|---|---|
| 7 | 6.25 | 1 | x | 2.5 | 5.00 | 2.5 | 5.00 | 2.5 | 5.00 |
| 8 | 6.25 | 1 | x | 2.5 | 5.00 | 2.5 | 5.00 | 2.5 | 5.00 |
| 9 | 6.25 | 1 | x | 2.5 | 5.00 | 2.5 | 5.00 | 2.5 | 5.00 |
| 10 | 6.25 | 1 | x | 2.5 | 5.00 | 2.5 | 5.00 | 2.5 | 5.00 |
| 11 | 6.25 | 1 | x | 3.50 | 6.00 | 3.50 | 6.00 | 3.50 | 6.00 |
| 12 | 6.25 | 1 | x | 3.50 | 6.00 | 3.50 | 6.00 | 3.50 | 6.00 |
| 13 | 6.25 | 1 | x | 3.50 | 6.00 | 3.50 | 6.00 | 3.50 | 6.00 |
| 14 | 6.25 | 1 | x | 3.50 | 6.00 | 3.50 | 6.00 | 3.50 | 6.00 |
| 15 | 6.25 | 1 | x | 3.50 | 6.00 | 3.50 | 6.00 | 3.50 | 6.00 |
| 16 | 6.25 | 1 | x | 3.50 | 6.00 | 3.50 | 6.00 | 3.50 | 6.00 |
| 17 | 6.25 | 1 | x | 3.50 | 6.00 | 3.50 | 6.00 | 3.50 | 6.00 |
| 18 | 6.25 | 1 | x | 3.50 | 6.00 | 3.50 | 6.00 | 3.50 | 6.00 |
| 19 | 6.25 | 1 | x | 3.50 | 6.00 | 3.50 | 6.00 | 3.50 | 6.00 |
| 20 | 6.25 | 1 | x | 3.50 | 6.00 | 3.50 | 6.00 | 3.50 | 6.00 |
| 21 | 6.25 | 1 | x | 3.50 | 6.00 | 3.50 | 6.00 | 3.50 | 6.00 |
| 22 | 6.25 | 1 | x | 3.50 | 6.00 | 3.50 | 6.00 | 3.50 | 6.00 |
| 23 | 6.25 | 1 | x | 3.50 | 6.00 | 3.50 | 6.00 | 3.50 | 6.00 |
| 24 | 6.25 | 1 | x | 3.50 | 6.00 | 3.50 | 6.00 | 3.50 | 6.00 |
| 25 | 6.25 | 1 | x | 3.50 | 6.00 | 3.50 | 6.00 | 3.50 | 6.00 |
| | | | | Non-sticky on | | Non-sticky on | | Non-sticky on | |
| | | | | charge 19 | | charge 16 | | charge 16 | |
| 26 | 9.37 | 1 | x | 3.00 | 5.50 | 2.83 | 5.33 | 2.25 | 4.92 |
| 27 | 9.37 | 1 | x | 2.57 | 5.07 | 2.57 | 5.07 | 2.50 | 5.00 |
| 28 | 9.37 | 1 | x | 2.50 | 5.00 | 2.50 | 5.00 | 2.57 | 5.07 |
| 29 | 9.37 | 1 | x | 2.33 | 4.83 | 2.35 | 4.85 | 2.35 | 4.85 |
| 30 | 9.37 | 1 | x | 2.33 | 4.83 | 2.37 | 4.87 | 2.37 | 4.87 |
| 31 | 9.37 | 1 | x | 2.17 | 4.67 | 2.17 | 4.67 | 2.08 | 4.58 |
| 32 | 9.37 | 1 | x | 2.25 | 4.75 | 2.33 | 4.83 | 2.25 | 4.75 |
| 33 | 9.37 | 1 | x | 2.50 | 5.00 | 2.50 | 5.00 | 2.17 | 4.67 |
| 34 | 9.37 | 1 | x | 2.50 | 5.00 | 2.50 | 5.00 | 2.17 | 4.40 |
| 35 | 9.37 | 1 | x | 2.42 | 4.92 | 2.67 | 5.16 | 2.08 | 4.58 |
| 36 | 9.37 | 1 | x | 2.25 | 4.75 | 2.25 | 4.75 | 2.00 | 4.50 |
| 37 | 9.37 | 1 | x | 2.08 | 4.58 | 2.08 | 4.58 | 2.08 | 4.58 |
| 38 | 9.37 | 1 | x | 2.08 | 4.58 | 2.08 | 4.58 | 2.08 | 4.58 |
| 39 | 9.37 | 1 | x | 2.08 | 4.58 | 2.17 | 4.67 | 2.08 | 4.58 |
| 40 | 9.37 | 1 | x | 2.08 | 4.58 | 2.17 | 4.67 | 2.00 | 4.50 |
| 41 | 9.37 | 1 | x | 2.33 | 4.83 | 2.33 | 4.83 | 2.00 | 4.50 |
| 42 | 9.37 | 1 | x | 2.17 | 4.67 | 2.33 | 4.83 | 2.08 | 4.58 |
| 43 | 9.37 | 1 | x | 2.17 | 4.67 | 2.42 | 4.92 | 2.08 | 4.58 |
| 44 | 9.37 | 1 | x | 2.33 | 4.83 | 2.33 | 4.83 | 2.08 | 4.58 |
| 45 | 9.37 | 1 | x | 2.33 | 4.83 | 2.42 | 4.92 | 2.08 | 4.58 |
| 46 | 9.37 | 0 | x | 3.67 | 6.17 | 3.92 | 6.33 | 3.33 | 5.83 |
| 47 | 9.37 | 0 | x | 3.75 | 6.25 | 3.75 | 6.25 | 3.00 | 5.50 |
| 48 | 9.37 | 0 | x | 3.67 | 6.17 | 3.58 | 6.08 | 2.83 | 5.33 |
| 49 | 9.37 | 0 | x | 3.67 | 6.17 | 3.67 | 6.17 | 3.00 | 5.50 |
| 50 | 9.37 | 0 | x | 3.92 | 6.42 | 3.67 | 6.17 | 2.75 | 5.25 |
| 51 | 9.37 | 0 | x | 4.00 | 6.50 | 3.83 | 6.33 | 3.33 | 5.83 |
| 52 | 9.37 | 0 | x | 4.17 | 6.67 | 4.00 | 6.50 | 3.00 | 5.50 |
| 53 | 9.37 | 0 | x | 4.00 | 6.50 | 4.00 | 6.50 | 3.00 | 5.50 |
| 54 | 9.37 | 0 | x | 3.67 | 6.17 | 3.58 | 6.08 | 2.92 | 5.54 |
| 55 | 9.37 | 0 | x | 3.92 | 6.63 | 3.75 | 6.25 | 3.00 | 5.50 |
| 56 | 12.5 | 0 | x | 4.00 | 6.50 | 3.83 | 6.33 | 2.92 | 5.42 |
| 57 | 12.5 | 0 | x | 4.17 | 6.67 | 4.29 | 6.50 | 2.92 | 5.42 |
| 58 | 12.5 | 0 | x | 4.00 | 6.50 | 4.00 | 6.50 | 3.00 | 5.50 |
| 59 | 12.5 | 0 | x | 3.67 | 6.17 | 3.58 | 6.08 | 3.00 | 5.50 |
| 60 | 12.5 | 0 | x | 3.92 | 3.42 | 3.75 | 6.25 | 3.00 | 5.50 |
| 61 | 12.5 | 0 | x | 3.17 | 5.67 | 3.25 | 5.75 | 2.67 | 5.17 |
| 62 | 12.5 | 0 | x | 3.08 | 5.58 | 3.08 | 5.58 | 3.00 | 5.50 |
| 63 | 12.5 | 0 | x | 3.25 | 5.75 | 3.33 | 5.83 | 2.50 | 5.00 |
| 64 | 12.5 | 0 | x | 3.67 | 6.17 | 3.17 | 5.67 | 2.58 | 5.08 |
| 65 | 12.5 | 0 | x | 3.58 | 6.08 | 3.25 | 5.75 | 2.67 | 5.17 |
| 66 | 12.5 | 0 | x | 3.00 | 5.50 | 3.33 | 5.83 | 2.88 | 5.38 |
| 67 | 12.5 | 0 | x | 3.03 | 5.53 | 3.18 | 5.68 | 2.83 | 5.33 |
| 68 | 12.5 | 0 | x | 2.83 | 5.33 | 2.88 | 5.38 | 2.75 | 5.25 |
| 69 | 12.5 | 0 | x | 2.83 | 5.33 | 2.83 | 5.33 | 2.68 | 5.18 |
| 70 | 12.5 | 0 | x | 2.68 | 2.18 | 2.66 | 5.16 | 2.45 | 4.95 |

| | | | |
|---|---|---|---|
| Total Time, minutes [Charges 26-70] | 248.50 | 247.64 | 227.88 |

TABLE 4

| | | | | Maltitol-Gum Arabic | | | | Maltitol-Repl 1 Fast | |
|---|---|---|---|---|---|---|---|---|---|
| | | | | Air to | | Maltitol-Repl. 1 Std. | | Air to | |
| | Syrup | Syrup Temp. | Mix Time | Free Flow, | Cycle Time, | Free Flow, | Cycle Time, | Free Flow, | Cycle time, |
| Charge # | wt, g | 0° C. | After Syrup | min | min | min | min | min | min |
| 26 | 6.1 | 60 | 1 | 2.25 | 4.75 | 2.25 | 4.75 | 2.00 | 4.50 |
| 27 | 6.1 | 60 | 1 | 2.08 | 4.58 | 2.08 | 4.58 | 2.08 | 4.58 |
| 28 | 6.1 | 60 | 1 | 2.08 | 4.58 | 2.08 | 4.58 | 2.08 | 4.58 |
| 29 | 6.1 | 60 | 1 | 2.08 | 4.58 | 2.17 | 4.67 | 2.08 | 4.58 |
| 30 | 6.1 | 60 | 1 | 2.08 | 4.58 | 2.17 | 4.67 | 2.00 | 4.50 |
| 31 | 6.1 | 60 | 1 | 2.33 | 4.84 | 2.33 | 4.67 | 2.00 | 4.50 |
| 32 | 6.1 | 60 | 1 | 2.17 | 4.67 | 2.33 | 4.83 | 2.08 | 4.58 |
| 33 | 6.1 | 60 | 1 | 2.17 | 4.67 | 2.42 | 4.83 | 2.08 | 4.58 |
| 34 | 6.1 | 60 | 1 | 2.33 | 4.83 | 2.33 | 4.83 | 2.08 | 4.58 |
| 35 | 6.1 | 60 | 1 | 2.33 | 4.83 | 2.42 | 4.92 | 2.08 | 4.58 |
| 36 | 6.1 | 25 | 1 | 3.00 | 5.50 | 2.83 | 5.33 | 2.25 | 4.92 |
| 37 | 6.1 | 25 | 1 | 2.57 | 5.07 | 2.57 | 5.07 | 2.50 | 5.00 |
| 38 | 6.1 | 25 | 1 | 2.50 | 5.00 | 2.50 | 5.00 | 2.57 | 5.07 |
| 39 | 6.1 | 25 | 1 | 2.33 | 4.83 | 2.35 | 4.85 | 2.35 | 4.85 |
| 40 | 6.1 | 25 | 1 | 2.33 | 4.83 | 2.37 | 4.87 | 2.37 | 4.87 |
| 41 | 6.1 | 25 | 1 | 2.17 | 4.67 | 2.17 | 4.67 | 2.08 | 4.58 |
| 42 | 6.1 | 25 | 1 | 2.25 | 4.75 | 2.33 | 4.83 | 2.25 | 4.75 |
| 43 | 6.1 | 25 | 1 | 2.50 | 5.00 | 2.50 | 5.00 | 2.17 | 4.67 |
| 44 | 6.1 | 25 | 1 | 2.50 | 5.00 | 2.50 | 5.00 | 2.17 | 4.40 |
| 45 | 6.1 | 25 | 1 | 2.42 | 4.92 | 2.67 | 5.16 | 2.08 | 4.58 |
| 46 | 6.1 | 60 | x | 3.67 | 6.17 | 3.92 | 6.33 | 3.33 | 5.83 |
| 47 | 6.1 | 60 | x | 3.75 | 6.25 | 3.75 | 6.25 | 3.00 | 5.50 |
| 48 | 6.1 | 60 | x | 3.67 | 6.17 | 3.58 | 6.08 | 2.83 | 5.33 |
| 49 | 6.1 | 60 | x | 3.67 | 6.17 | 3.67 | 6.17 | 3.00 | 5.50 |
| 50 | 6.1 | 60 | x | 3.92 | 6.42 | 3.67 | 6.17 | 2.75 | 5.25 |
| 51 | 6.1 | 60 | x | 4.00 | 6.50 | 3.83 | 6.33 | 3.33 | 5.83 |
| 52 | 6.1 | 60 | x | 4.17 | 6.67 | 4.00 | 6.50 | 3.00 | 5.50 |
| 53 | 6.1 | 60 | x | 4.00 | 6.50 | 4.00 | 6.50 | 3.00 | 5.50 |
| 54 | 6.1 | 60 | x | 3.67 | 6.17 | 3.58 | 6.08 | 2.92 | 5.42 |
| 55 | 6.1 | 60 | x | 3.92 | 6.63 | 3.75 | 6.25 | 3.00 | 5.50 |
| 56 | 6.1 | 25 | x | 4.00 | 6.50 | 3.83 | 6.33 | 2.92 | 5.42 |
| 57 | 6.1 | 25 | x | 4.17 | 6.67 | 4.90 | 6.50 | 2.92 | 5.42 |
| 58 | 6.1 | 25 | x | 4.00 | 6.50 | 4.00 | 6.50 | 3.00 | 5.50 |
| 59 | 6.1 | 25 | x | 3.67 | 6.17 | 3.58 | 6.08 | 3.00 | 5.50 |
| 60 | 6.1 | 25 | x | 3.92 | 6.42 | 3.75 | 6.25 | 3.00 | 5.50 |
| 61 | 6.1 | 25 | x | 3.17 | 5.67 | 3.25 | 5.75 | 2.67 | 5.17 |
| 62 | 6.1 | 25 | X | 3.08 | 5.58 | 3.08 | 5.58 | 3.00 | 5.50 |
| 63 | 6.1 | 25 | X | 3.25 | 5.75 | 3.33 | 5.83 | 2.50 | 5.00 |
| 64 | 6.1 | 25 | X | 3.67 | 6.17 | 3.17 | 5.67 | 2.58 | 5.08 |
| 65 | 6.1 | 25 | X | 3.58 | 6.08 | 3.25 | 5.75 | 2.67 | 5.17 |

| | | | |
|---|---|---|---|
| Total Time, minutes [Charges 25-65] | 221.64 | 220.01 | 201.67 |

Table 5 includes hardness of chewing gum sugar shell comparing gum arabic (Acacia Seyal) and Replacements 1 Std. and Replacement 1 Fast. The hardness of chewing gum sugar shell in Table 5 shows comparable or higher fracture Force values for the Replacements over gum arabic. Replacement 1 Fast, which contains a fast crystallizing ingredient, even when used at 2/3 the usage of gum arabic shows quite comparable shell strength in gum center # 1. When used at the same usage in chewing gum center #2, Replacement 1 Fast yielded a significantly higher fracture Force compared to gum arabic and Replacement 1 Std., an improvement in functionality that is achieved by manipulating the base composition.

TABLE 5

| | Maltitol-gum | | Maltitol-Repl. 1 | | Maltitol-Repl. 1 | |
|---|---|---|---|---|---|---|
| | Arabic | | Std. | | Fast | |
| | Force | Distance | Force | Distance | Force | Distance |
| | g | mm | g | mm | g | mm |
| Center # 1 | | | | | | |
| [1.0 cm × | | | | | | |
| 2.1 cm] | | | | | | |
| Average | 828.0 | 0.25 | 944.5 | 0.27 | 781.6* | 0.23 |
| Std. Dev. | 99.7 | 0.044 | 56.8 | 0.04 | 59.2 | 0.043 |
| N | 50 | | 50.0 | | 50 | |
| Center #2 | | | | | | |
| [1.1 cm × | | | | | | |
| 1.9 cm] | | | | | | |
| Average | 647.2 | 0.202 | 683.0 | 0.233 | 757.5 | 0.273 |
| Std. Dev. | 84.6 | 0.028 | 134.7 | 0.034 | 148.8 | 0.103 |
| n | 50.0 | | 50.0 | | 50.0 | |

*at ⅔ the usage in the syrup

Sealing of Peanuts Example: In this example, gum arabic replacements were also tested in sealing of peanuts to provide both oil and oxygen barriers, by applying the syrup at 40° Brix in 3 charges with and without dusting powder but drying in between syrup charges. Viscosities of these syrups are shown in Table 6 illustrating viscosities of 40° Brix sealing syrup comparing gum arabic and Replacements 1 & 2. The viscosities are very comparable with the Acacia Seyal and Acacia Senegal. The dusting powder used was a 50:50 blend of cocoa and flour. Drying times were compared and sealed peanuts were subjected to a sensory test after 2 months of storage in a capped plastic jar.

TABLE 6

| | Ave. Viscosity | Ave. Viscosity |
|---|---|---|
| Gum System (40°Brix) | at 25° C., cP | at 60° C., cP |
| Gum Arabic, Acacia Seyal | 800 | 225 |
| Gum Arabic, Acacia Senegal | 1040 | 394 |
| Replacement 1 Std. | 799 | 196 |
| Replacement 1 Fast | 914 | 267 |
| Replacement 1 All Natural | 753 | 205 |

Table 7 is directed towards sealing of peanut centers comparing gum arabic and Replacement 1 and Replacement 1 using a batch weight of 1000 g; syrup charge of 10 g; dusting powder-cocoa:flour 50:50 ratio of 10 g. Referring to Table 7, drying times were comparable between gum arabic and Replacement 1 Std. However, Replacement 1 Fast, containing a fast-crystallizing ingredient, shows a significantly faster drying time. Moreover, it protected the peanuts from oxidation and rancidity indicating that it was a better film former.

TABLE 7

| | | Time to | Drying Time |
|---|---|---|---|
| | | Free Flow | to Next |
| | | Minutes | Charge Minutes |
| | | Average of | Average of |
| Sealing Syrup | Charge# | 3 Trials | 3 Trials |
| 40% Gum Arabic Syrup | | | |
| With Dusting Powder | 1 | 2.50 | 4.33 |
| With Dusting Powder | 2 | 2.11 | 3.19 |
| With Dusting Powder | 3 | 2.39 | 4.67 |
| Total | | 7.00 | 12.19 |
| No Dusting Powder | 1 | 2.94 | 4.67 |
| No Dusting Powder | 2 | 2.92 | 4.91 |
| No Dusting Powder | 3 | 3.54 | 6.00 |
| Total | | 9.40 | 15.58 |
| Sensory (after 2 months) | Rancid smell | | |
| 40% Repl. 1 Std. Syrup | | | |
| With Dusting Powder | 1 | 2.29 | 3.69 |
| With Dusting Powder | 2 | 1.97 | 4.94 |
| With Dusting Powder | 3 | 2.24 | 4.22 |
| Total | | 6.50 | 12.85 |
| No Dusting Powder | 1 | 3.36 | 5.78 |
| No Dusting Powder | 2 | 3.84 | 5.33 |
| No Dusting Powder | 3 | 3.50 | 5.67 |
| Total | | 10.70 | 16.78 |
| Sensory (after 2 months) | Slight rancid smell | | |
| 40% Repl. 1 Fast Syrup | | | |
| With Dusting Powder | 1 | 1.53 | 2.83 |
| With Dusting Powder | 2 | 1.50 | 3.06 |
| With Dusting Powder | 3 | 1.70 | 2.78 |
| Total | | 4.73 | 8.67 |
| No Dusting Powder | | 1.55 | 3.67 |
| No Dusting Powder | 1 | 1.64 | 4.11 |
| No Dusting Powder | 2 | 2.06 | 4.61 |
| Total | 3 | 5.25 | 12.39 |

| | |
|---|---|
| Sensory (after 2 months) | No rancid smell |

Pastilles Example: In this example, batches of pastille candies were prepared without gum, with gum arabic (Acacia Seyal), Replacement 1 Std., Replacement 1 Fast and Replacement 1 All Natural using the formulas below. Table 8 describes the formulas for the pastilles.

TABLE 8

| | | With | With | With | With |
|---|---|---|---|---|---|
| | Control | Acacia | Repl. 1 | Repl. 1 | Repl. 1 |
| | (No Gum) | Seyal | Std. | Fast | all Natural |
| Sugar | 59.50 | 56.00 | 56.00 | 56.00 | 56.00 |
| Corn Syrup | 25.50 | 24.00 | 24.00 | 24.00 | 24.00 |
| Water | 13.43 | 13.43 | 13.43 | 13.43 | 13.43 |
| Citric Acid | 0.75 | 0.75 | 0.75 | 0.75 | 0.75 |
| Malic Acid | 0.75 | 0.75 | 0.75 | 0.75 | 0.75 |
| Flavor | 0.07 | 0.07 | 0.07 | 0.07 | 0.07 |
| Gum System | 0.00 | 5.00 | 5.00 | 5.00 | 5.00 |

In this example, water and corn syrup were first added to the cooking pan. Sugar and gum system were dry-blended and added to the batch while mixing. Then the mixture was heated to about 148 to 150° C., heat was turned off, and acids and flavor were added. While still liquid and hot, the candy syrup was poured into molds. When candies crystallized, they were placed in the humidity chamber overnight at about 12% relative humidity (RH), packed and refrigerated to prevent sweating. Hardness of the candies was measured using TA XT Texture Analyzer.

Replacement 1 Std., Replacement 1 Fast and Replacement 1 All Natural increased the hardness of the candy by the same magnitude or even slightly higher than the gum arabic (Acacia Seyal) over that of the control with no gums added. In terms of color, gum arabic seemed to brown more than the Replacements. Table 9 includes hardness values of the pastille cubes made with gum arabic and the Replacements compared to the control candy with sugar only; average of 2 trials and 6 to 20 replications per trial.

The hardness of the candies in terms of grams force needed to crack were input into the table. Referring to Table 9, the control candy with sugar alone and no gums has the lowest hardness value. Candies made with Replacement 1 Std. and Replacement 1 Fast showed comparable or slightly higher hardness values compared to gum arabic.

TABLE 9

| | Force 1 | Distance 1 |
|---|---|---|
| Pastille Samples | g | mm |
| Control [no gum, sugar only] | | |
| Average | 11396 ± 1552 | 2.778 |
| With Gum Arabic | | |
| Average | 12346 ± 2098 | 2.372 |
| With Replacement 1 Std. | | |
| Average | 12886 ± 2173 | 2.468 |
| With Replacement 1 Fast | | |
| Average | 13336 ± 2469 | 2.084 |
| With Replacement 1 All | | |
| Natural | | |
| Average | 12904 ± 2353 | 2.669 |

Flavor Encapsulation Example: In this example, an orange oil emulsion was prepared by dissolving 160 grams of gum arabic or Replacements 3 and 4 in 240 grams of water and mixing for 2 hours. Then 35 grams of the oil was added, mixed for 5 minutes and then mixed using Ross Mixer, model ME 100 L for 3 minutes at about 2000 RPM to make a coarse emulsion. The stability of the emulsion was monitored up to 16 hours using the Turbiscan Lab Expert (Formulaction) to see the movement of the oil droplets and/or separation of water and oil layers with time. For flavor emulsions to be spray-dried, the requirement for the emulsion is to be stable over the period from preparation to spray drying, which could be about 4 hours. Hence, an emulsion that did not separate within 6 to 16 hours indicates that that emulsifier is working sufficiently. In the spray drying study, the emulsions were spray-dried immediately following Ross mixing. All viscosities of emulsions were in line with each other and mechanically the batches behaved the same way during spray drying. The finished powders were compared using a sensory test.

Table 10 is directed towards orange oil emulsion for spray drying comparing gum arabic and gum arabic Replacements with different emulsifiers. That is, Table 10 shows the viscosity and visual appearance of the emulsions prepared with gum arabic control, Replacement 2 with OSA-modified gum emulsifier, Replacement 2 with emulsifying starch and with Replacement 4 with a natural emulsifier. All emulsions did not show signs of separation visually. Turbiscan profiles were conducted with each sample in Table 10 and the profiles confirmed that all samples were stable within the first 5-6 hours. None showed water separation indicated by a drastic reduction or shifts in refractive index with time around the bottom of the sample tube (>0 mm to 10 mm). Similarly, there was no creaming indicated by bumps around 40 mm. There were noticeable shifts within 2 hours in the Turbiscan profiles of the emulsions with OSA-modified gum and emulsifying starch due to foam or air bubbles bursting, rather than oil coalescing. At about 18 hours, the Acacia Seyal control showed signs of creaming as a bump in the Turbiscan profile at about 40 mm or top layer on the sample tube. Although, Acacia Senegal and the Replacements did not show signs of creaming. However, since spray drying happens within 4 hours or so, from a technical point of view, all emulsions using gum arabic and various iterations of Replacements 2 passed the stability test.

TABLE 10

| | | | Repl. 2 with | Repl. 2 with | Repl. 2 with |
|---|---|---|---|---|---|
| | | | OSA-modified | OSA-starch | natural |
| | Acacia Seyal | Acacia Senegal | gum emulsifier | emulsifier | emulsifiers |
| Immediate | 292 | 349 | 354 | 354 | 249 |
| Viscosity | | | | | |
| (~45° C.), cP | | | | | |
| 4-h Viscosity | 504 | 726 | 868 | 836 | 596 |
| (25-27° C.), cP | | | | | |
| 4-h Emulsion | No separation | No separation | No separation | No separation | No separation |
| Appearance | | | | | |
| 24-h Emulsion | Water layer at | No separation | No separation | No separation | No separation |
| Appearance | bottom | | | | |

Edible Film Glitter Example: In this example, edible glitters were prepared. The prepared edible glitters included an Acacia Seyal gum arabic and Replacements compositions from Method 2 were used in the edible film glitter recipe containing 40% gum arabic or the Replacement compositions, 0.8% glycerin and 59.2% water. The gum was dissolved in water and glycerin at room temperature for 1 hour, then cast at 10 mils thickness, dried in a controlled humidity oven at 12% RH, scraped off and packed. A scale up trial using gum arabic and the Replacement compositions was also done with added potassium stearate as a release agent. The cast films show similar cracking patterns for Acacia Seyal, Replacements 2 with OSA-modified gum emulsifier and Replacement 2 All Natural.

FIG. 10A illustrates an Acacia Seyal edible glitter according to an example of the invention. FIG. 4-0.1310B illustrates a replacement 2 with OSA modified gum edible glitter according to another example of the invention. FIG. 10C illustrates Replacement 2 all natural emulsifier edible glitter according to another example of the invention. Referring to FIGS. 10A-10C, the resulting glitters compare very well with each other in sheen and size of the flakes. Scale up trial also showed the same processing behavior between gum arabic and the replacements.

Lithography Example: In this example, a lithographic solution, gum arabic [Acacia Seyal] and various replacement compositions from Method 3 were compared using two methods of incorporation, such as: 1) by adding the powder (7.58%) directly into the lithographic solution (92.42%), and 2) by preparing a 14° Baume solution and adding this (28.6%) to the lithographic solution (71.4%). The solutions were monitored for separation after 1 to 10 days.

Very few gums or polysaccharides are compatible or stable in aqueous lithographic solution or fountain solution and would either form a colloidal layer at the top or bottom of the container within 1 day. The best stability is seen with anionic gums such as xanthan and cellulose gum among other negatively charged gums that contain an OSA-modified gum emulsifier. No separation was seen using Method 3 Replacement compositions after 10 days regardless of method of incorporation.

Although the disclosure has been described and illustrated with a certain degree of particularity, it is understood that the disclosure has been made only by way of example, and that numerous changes in the conditions and order of steps can be resorted to by those skilled in the art without departing from the spirit and scope of the disclosure.

What is claimed:

1. A method of preparing a gum arabic replacement, partial replacement or extending composition, for use in panning, candy, coating and adhesion applications, comprising the steps of:
selecting a strong (key) film former of natural and/or modified polysaccharides that comprises between approximately 0.1% and approximately 10% of a total composition, or used at a level in the finished application equivalent to about 0.1 to 10% of what gum arabic would typically be used regardless of whether the gum arabic is used.

2. The method of claim 1 further comprising the step of adding a low viscosity cracking agent to generate a 1 to 1 replacement of gum arabic, wherein the low viscosity cracking agent comprises between approximately 0% and approximately 99.9% of the total composition, or used at a level in the finished application equivalent to about 0 to 99.9% of what gum arabic would typically be used regardless of whether the gum arabic is used, and wherein the composition has a viscosity at concentration of approximately 35°-40° Brix being about 10 cP to about 2000 cP at 25° C. and a film cast at 5 mils to 10 mils cracks into flakes on drying that lies between that of materials that can generate continuous films and materials that crystallize and do not form films at all.

3. The method of claim 1, further comprising the steps of adding a tackiness modifier, wherein the tackiness modifier comprises between about 0% and approximately 10% of the total composition, or used at a level in the finished application equivalent to about 0 to 10% of what gum arabic would typically be used regardless of whether the gum arabic is used.

4. The method of claim 1, further comprising the steps of adding a fast-crystallizing agent, wherein the fast-crystallizing agent comprises between about 0% and about 99.9% of the total composition, or used at a level in the finished application equivalent to about 0 to 99.9% of what gum arabic would typically be used regardless of whether the gum arabic is used.

5. The method of claim 1, wherein the strong (key) film former of natural and/or modified polysaccharide is selected from the group consisting of cellulose gum, methyl cellulose, hydroxypropyl methylcellulose (HPMC), propylene glycol alginate, carrageenan, pectin, alginate, gellan, agar, konjac, xanthan, fenugreek, guar, tara, locust bean gum, starch, and combinations thereof.

6. The method of claim 1, wherein the low viscosity cracking agent is selected from the group consisting of maltodextrin, monosaccharides, disaccharides, oligosaccharides, larch gum, polydextrose, and combinations thereof.

7. The method of claim 2, wherein the tackiness modifier is selected from the group consisting of starch, guar gum, locust bean gum and combinations thereof

8. The method of claim 3, wherein the fast-crystallizing agent is selected from the group consisting of inulin, erythritol, low DE maltodextrin, lactose, and combinations thereof.

9. The method of claim 1, wherein the gum arabic replacement, partial replacement or extending composition is used in panning, candy, coating and adhesion applications.

10. A method of using a gum arabic replacement, partial replacement or extending composition as an agent to bind and strengthen a sugar or sugar-alcohol shell coat, seal oil containing centers, strengthen candies and adhere seeds and cereal pieces, comprising the steps of:
applying an aqueous gum arabic replacement, partial replacement or extending composition as an agent to bind and strengthen a sugar or sugar-alcohol shell coat, seal oil containing centers, strengthen candies and adhere seeds and cereal pieces together, wherein the composition comprises:
a strong (key) film former of natural and/or modified gum being about 0.1% to about 10% of a total composition, or used at a level in the finished application equivalent to about 0.1 to 10% of what gum arabic would typically be used regardless of whether gum arabic is used;
as needed, a low viscosity cracking agent, wherein the low viscosity cracking agent comprises between approximately 0% and approximately 99.9% of the total composition, or used at a level in the finished application equivalent to about 0 to 99.9% of what gum arabic would typically be used regardless of whether the gum arabic is used;
as needed, a tackiness modifier, wherein the tackiness modifier comprises between about 0% and approximately 10% of the total composition or used at a level in the finished application equivalent to about 0 to 10% of what gum arabic would typically be used regardless of whether the gum arabic is used; and,
as needed, a fast-crystallizing agent, wherein the fast-crystallizing agent comprises between about 0% and about 99.8% of the total composition or used at a level in the finished application equivalent to about 0 to 99.8% of what gum arabic would typically be used regardless of whether the gum arabic is used.

11. The method of claim 10, wherein the strong (key) film former of natural and/or modified gum is selected from the group consisting of cellulose gum, methyl cellulose, hydroxypropyl methylcellulose (HPMC), propylene glycol alginate, carrageenan, pectin, alginate, gellan, agar, konjac, xanthan, fenugreek, guar, tara, locust bean gum, starch, and combinations thereof.

12. The method of claim 10, wherein the low viscosity cracking agent is selected from the group consisting of maltodextrin, monosaccharides, disaccharides, oligosaccharides, larch gum, polydextrose, and combinations thereof.

13. The method of claim 10, wherein the tackiness modifier selected from the group consisting of starch, guar gum, locust bean gum and combinations thereof.

14. The method of claim 9, wherein the fast-crystallizing agent is selected from the group consisting of inulin, erythritol, low DE maltodextrin, lactose, and combinations thereof.

15. A method of preparing a gum arabic replacement, partial replacement or extending composition as an encapsulating agent for spray-dried flavors or as an edible film, comprising the steps of:
selecting a strong (key) film former of natural and/or modified polysaccharide that comprises between approximately 0.1% and approximately 10% of a total composition, or used at a level in the finished application equivalent to about 0.1 to 10% of what gum arabic would typically be used regardless of whether gum arabic is used;
adding a natural and/or modified emulsifier that provides stable flavor emulsion for at least 4 to 6 hours from preparation and wherein such natural and/or modified emulsifier can be an optional ingredient when replacing gum arabic in edible glitter, wherein such emulsifier comprises about 0.1% to about 25% of the total composition; and
adding a low viscosity polysaccharide being about 50% to about 99.9% of the total composition, wherein the composition has a viscosity at concentrations of about 35-40° Brix of being about 10 cP to about 2000 cP at 25° C.

16. The method of claim 15, wherein the strong (key) film former of natural and/or modified polysaccharide is selected from the group consisting of cellulose gum, methyl cellulose, hydroxypropyl methylcellulose (HPMC), propylene glycol alginate, carrageenan, pectin, alginate, gellan, agar, konjac, xanthan, fenugreek, guar, tara, locust bean gum, starch, and combinations thereof.

17. The method of claim 15, wherein the natural and/or modified emulsifier is selected from the group consisting of propylene glycol alginate, emulsifying starch, OSA-modified gums, ghatti, tragacanth, high efficacy gum Acacia emulsifier, soy lecithin, monoglycerides, diglycerides, proteins and combinations thereof.

18. The method of claim 15, wherein the low viscosity polysaccharide is selected from the group consisting of maltodextrin, inulin, larch gum, polydextrose, and combinations thereof

19. A method of using a gum arabic replacement, partial replacement or extending composition in a lithography or printing application, comprising the steps of:
selecting an anionic polysaccharide being about 0.1% to about 10% of a total composition, wherein the anionic polysaccharide is selected from the group consisting of xanthan gum, cellulose gum, alginate, ghatti, karaya, and combinations thereof;
adding an emulsifier and surface-adhesion modifier being about 0.1% to about 25% of the total composition, wherein the emulsifier and surface-adhesion modifier is selected from the group consisting of propylene glycol alginate, OSA modified gums, high efficacy gum Acacia emulsifier, tragacanth and combinations thereof; and
adding a low viscosity solvent-resistant polysaccharide selected from the group consisting of maltodextrin, larch gum, inulin, polydextrose, and combinations thereof and being about 65% to about 99.8% of the total composition, and wherein the composition has a viscosity at concentration of about 14° Baume of being about 10 cP to about 900 cP at 25° C.
